(19) United States
(12) Patent Application Publication
(10) Pub. No.: US 2006/0211133 A1
(43) Pub. Date: Sep. 21, 2006

(54) Ultra-low volume fraction collection and analysis

(75) Inventors: Thomas N. Corso, Groton, NY (US); Colleen K. Van Pelt, Groton, NY (US); Jie Li, Ithaca, NY (US)

Correspondence Address: NIXON PEABODY LLP - PATENT GROUP, CLINTON SQUARE, P.O. BOX 31051, ROCHESTER, NY, 14603-1051, US

(73) Assignee: Advion BioSciences, Inc., Ithaca, NY (US)

(21) Appl. No.: 11/348,807

(22) Filed: Feb. 7, 2006

Related U.S. Application Data
(60) Provisional application No. 60/721,404, filed on Sep. 28, 2005.
(60) Provisional application No. 60/650,482, filed on Feb. 7, 2005.

(51) Int. Cl. G01N 1/10

(52) U.S. Cl. 436/180

(57) ABSTRACT

An ultra-low volume fraction collection and concentration method provides practical application in collecting fractions, e.g. as low as 25 nL, from nanoLC columns into pipette tips at user-defined timed-intervals. The fractions are dried to create a concentrated band at the very end of the interior of the pipette tip and subsequently reconstituted directly in the pipette tips in solvent prior to analysis. As the chromatography and reconstitution solvent choice are independent, the reconstitution solvent can be selected to maximize ionization efficiency without compromising chromatography separation. In the infusion analysis of the nanoLC fractions, a low flow electrospray chip enables each nanoLC fraction to be analyzed for over ten minutes. This increase in analysis time allows for advantages over prior methods. Optionally, the nanoLC fractions can be archived in the pipette tips for analysis at a later date.

### CROSS REFERENCE TO RELATED APPLICATIONS

This application claims the benefit of the filing date of prior Provisional Patent Application Nos. 60/721,404, filed Sep. 28, 2005, and 60/650,482, filed Feb. 7, 2005, which are both incorporated herein by reference in their entirety.

### BACKGROUND OF THE INVENTION

Liquid chromatography (“LC”) combined with mass spectrometry (“MS”), commonly known as LC/MS, has become one of the most powerful analytical techniques for qualitative and quantitative measurements. The development of electrospray ionization allowed for the practical mating of LC with MS which is widely used today. Dole et al., J. Chem. Phys., 49:2240-2249 (1968); Yamashita et al., Phys. Chem. 88:4451-4459 (1984). This LC/MS combination becomes especially powerful for trace analyses requiring high sensitivity and selectivity, as well as in proteomic applications, where the high sample complexity and large dynamic range of proteins present have necessitated the use of LC prior to MS. Washburn et al., Nature Biotechnology, 19:242-247 (2001); Link et al., Nature Biotechnology, 17:676-682 (1999). Although liquid chromatography and mass spectrometry are quite complementary, these two techniques cannot be coupled without some compromise.

The first compromise that is made when LC and MS are combined in direct sequence as a hyphenated technique is with the choice of solvent systems used. Often the optimal chromatography solvent is quite different from the optimal ionization solvent for MS analysis. For instance, it is well known that trifluoroacetic acid is a powerful additive for obtaining LC peak resolution, but it is unfortunately an ion suppressant in MS analysis. Mazza et al., J. Chromatogr. B, 790:91-97 (2003).

Additional issues that arise when coupling liquid chromatography and mass spectrometry are that the peak elution window of LC can be too narrow to perform all the desired MS experiments, (Staack et al., Rapid Commun. Mass Spectrom., 19:618-626 (2005); Chen et al., Anal. Chem., 77:2323-2331 (2005)) and further, in very complex peptide mixtures the number of ions co-eluting can exceed the number of ions for which tandem mass spectra can be acquired. Liu et al., Anal. Chem., 76:4193-4201 (2004). Recently developed mass spectrometers are able to scan significantly faster than older instruments so although this limitation may have improved, (Hager, Rapid Commun. Mass Spectrom., 16:512-526 (2002); Schwartz et al., J. Am. Soc. Mass Spectrom., 13:659-669 (2002)) there are many cases where neutral loss, precursor ion, or high resolution scanning is desired but simply cannot be performed on the LC timeframe. Furthermore, proteomic samples can be very complex and have wide dynamic ranges. Therefore, if the MS is not given adequate time to perform a complete interrogation, only information for the higher concentration components will be obtained. In addition, chromatography trends include the use of polymer monolith columns (Peters et al., Anal. Chem., 69:3646-3649 (1997); Peters et al., Anal. Chem., 70:2288-2295 (1998); Minakuchi et al., J. Chromatogr. A, 762:135-146 (1997); Minakuchi et al., J. Chromatogr. A, 797:121-131 (1998)) and columns with 1.5 to 3 μm size particles, (Shen et al., Anal. Chem., 73:1766-1775 (2001); Tolley et al., Anal. Chem., 73:2985-2991 (2001)) both of which lead to increasingly narrow peak widths, some as narrow as 3 seconds. Chen et al., Anal. Chem., 77:2323-2331 (2005); Emmett et al., J. Am. Soc. Mass Spectrom., 5:605-613 (1994).

A few techniques have been developed to overcome this issue of a too narrow peak width in chromatography analysis. Peak parking was developed in 1995 by Davis et al., Anal. Chem., 67:4549-4556 (1995); Davis et al., J. Am. Soc. Mass Spectrom., 8:1059-1069 (1997); Davis et al., J. Am. Soc. Mass Spectrom., 9:194-201 (1998). When a peak is detected the peak parking technique reduces flow rate approximately 10-fold, gradually eluting the peak from the column. Using peak parking, peak elution can be extended typically from 1.5 to 5 minutes. Murphy et al., Automated ESI Control on Variable-Flow Gradient Nanobore LC-MS. 52^{nd} ASMS Conference on Mass Spectrometry and Allied Topics, Nashville, Tenn. 2004. Once the peak of interest has completely eluted, the flow rate is returned to its initial higher flow rate. However, this analysis time extension for peak parking is not achievable for all molecules, as it depends on the retention of the analyte to the stationary phase of the column. Furthermore, this technique has several drawbacks, including spray performance issues arising from changing flow rates, compromised chromatography performance over the course of a run after many changes in flow rate, and finally, often the very low abundance peptides are the ones of most interest (Ogata et al., J. Proteome Res., 4:837-845 (2005)) and these low level species may not be selected for peak parking. A variation of peak parking uses valves to divert peak elution windows of interest to a transfer capillary where the desired elution is subsequently analyzed using a low flow rate. Vissers et al., J. Am. Soc. Mass Spectrom. 13:760-771 (2002). This approach is referred to as peak trapping, and it does offer benefits over peak parking, however the analysis solvent which is used is still dictated by the chromatography.

Another technique used to provide the mass spectrometer with longer analysis time is LC fraction collection. Fraction collection has been used extensively in metabolite identification (“ID”) applications where researchers need to elucidate structure. Staack et al., Rapid Commun. Mass Spectrom., 19:618-626 (2005); Drexler et al., Rapid Commun. Mass Spectrom., 12:895-900 (1998). In this approach LC fractions are collected into an intermediate structure such as a well microtitre plate and then the fractions of interest are subsequently interrogated. Current fraction collection technology resides in the μL/min and higher regime. Drexler et al., Rapid Commun. Mass Spectrom., 12:895-900 (1998). In contrast to proteomic applications, typically one is not sample limited in metabolite ID studies. Therefore, in most proteomic applications, one could not collect fractions into a well plate. This is because well plates are designed for handling microliter and milliliter volumes and thus are not applicable for sample limited applications, such as proteomics, as severe sample dilution would occur, limiting detection capability. Furthermore, use of well plates would require additional sample handling steps and substrates prior to MS analysis which could lead to adsorptive losses, limiting detection sensitivity. LC fraction collection has been performed for proteomic application using matrix assisted laser desorption ionization (“MALDI”). Chen et al., Anal. Chem., 77:2323-2331 (2005); Walker et al., Anal. Chem., 67:4197-4204 (1995); Miliotis et al., J. Mass Spectrom., 35:369-377 (2000); Griffin et al., Anal. Chem., 73:978-986 (2001). However, MALDI suffers from the generation of primarily singly charged analyte ions, which are not conducive to the promotion of fragmentation indicative of peptide sequence. Ashcroft, Nat. Prod. Rep., 20:202-215 (2003); Chalmers et al., Curr. Opin. Biotechnol., 11:384-390 (2000).

NanoLC with 75 μm id columns and flow rates of 200 nL/min is gaining in popularity due to improved resolution, lower sample injection requirements, and better ionization efficiency leading to improved sensitivity. NanoLC peaks typically elute within 20 sec, providing most modern mass spectrometers sufficient time to perform MS/MS for simple protein ID experiments. However, for complex samples, such as glycopeptides, where MS³ or MS⁴ experiments may be needed, nanoLC does not provide adequate analysis time.

Accordingly, a solution to the above-noted problems relating to fraction collection and analysis of nano-volume samples is desired.

### SUMMARY OF THE INVENTION

In accordance with one aspect of the present invention, there is provided a method for collecting low volume liquid sample including, positioning a deposition tube, having a dispensing end, within a collection tube, having a collection end, so that the end of the deposition tube protrudes out of the end of the collection tube; feeding a liquid sample through the deposition tube until a desired volume of sample forms a droplet at the end of the deposition tube; and retracting the deposition tube within the collection tube so that the sample droplet is collected in the end of the collection tube.

In accordance with another aspect of the present invention, there is provided a method for collecting low volume liquid sample including, positioning a deposition tube, having a dispensing end, within a collection tube, having a collection end, so that the end of the deposition tube is in a retracted or near co-planar position relative to the end of the collection tube; feeding a liquid sample through the deposition tube until a desired volume of sample collects within the end of the collection tube; and withdrawing the deposition tube completely from within the collection tube without disturbing the sample collected in the end of the collection tube.

In accordance with another aspect of the present invention, there is provided a method for collecting low volume liquid sample including, positioning a deposition tube, having a dispensing end, within a collection tube, having a collection end, so that the end of the deposition tube protrudes through the end of the collection tube and into the interior of the collection tube; feeding a liquid sample through the deposition tube until a desired volume of sample forms a droplet at the end of the deposition tube; and withdrawing the deposition tube from within the collection tube so that the sample droplet is collected in the end of the collection tube.

In accordance with another aspect of the present invention, there is provided a method for collecting low volume liquid sample including, positioning a deposition tube, having a dispensing end, within a collection tube, having a collection end, so that the dispensing end of the deposition tube protrudes through the end of the collection tube and into the interior of the collection tube in a protruded or near co-planar position relative to the end of the collection tube; feeding a liquid sample through the deposition tube until a desired volume of sample collects within the end of the collection tube; and withdrawing the deposition tube completely from within the collection tube without disturbing the sample collected in the end of the collection tube.

In accordance with another aspect of the present invention, there is provided a method for collecting and preparing for analysis low volume liquid sample including, positioning a deposition tube, having a dispensing end, within a collection tube, having a collection end, so that the dispensing end of the deposition tube is positioned to deliver a liquid sample to the collection end of the collection tube; feeding the liquid sample containing an analyte through the deposition tube until a desired volume of sample is collected in the collection end of the collection tube; and performing one or more of the following: concentrating the sample; drying the collected sample, aspirating a second liquid into the collection tube, reconstituting the dried sample in the collection tube, and injecting the sample to a detector for direct analysis; wherein the same tube is used for collection, reconstitution, and injection of the sample.

In accordance with another aspect of the present invention, there is provided a method including, drying a collected liquid; aspirating a solvent into the collection tube to reconstitute the dried sample; mixing and concentrating the reconstituted sample by exposing the sample to a desired number of cycles of expelling the sample and forming a droplet at the end of the collection tube exposing the expelled droplet to the atmosphere, and re-aspirating the droplet into the collection tube; and subjecting the sample to a detector for analysis.

In accordance with another aspect of the present invention, there is provided a method including, drying a collected sample; aspirating a liquid into the collection tube to reconstitute the dried sample; mixing and concentrating the reconstituted sample by agitation within the collection tube by exposing the sample to a desired number of cycles of aspiration and dispense such that the sample remains within the collection tube; and subjecting the sample to a detector for analysis.

In accordance with another aspect of the present invention, there is provided method including, drying a collected sample; aspirating a solvent into the collection tube to reconstitute the dried sample; allowing the solvent and sample to mix within the collection tube by holding the solvent within the collection tube for a desired amount of time; and subjecting the sample to a detector for analysis.

In accordance with another aspect of the present invention, there is provided a method including, concentrating a collected sample volume by exposing the sample to a desired number of cycles of expelling the sample and forming a droplet at the end of the collection tube exposing the expelled droplet to the atmosphere, and re-aspirating the droplet into the collection tube; and subjecting the sample to a detector for analysis.

In accordance with another aspect of the present invention, there is provided a method for collecting and preparing for analysis low volume liquid sample including, positioning a deposition tube, having a dispensing end, within a collection tube, having a collection end, so that the dispensing end of the deposition tube is positioned to deliver a liquid sample to the collection end of the collection tube; feeding the liquid sample containing an analyte through the deposition tube until a desired volume of sample is collected in the collection end of the collection tube; and performing one or more of the following: concentrating the sample; drying the collected sample, aspirating a second liquid into the collection tube, reconstituting the dried sample in the collection tube, and injecting the sample to a detector for direct analysis; wherein the same tube is used for collection, reconstitution, and injection of the sample.

In accordance with another aspect of the present invention, there is provided a method for concentrating a liquid sample including, collecting a liquid sample in a collection tube; concentrating the collected sample volume by exposing the sample to a desired number of cycles of expelling the sample and forming a droplet at the end of the collection tube exposing the expelled droplet to the atmosphere, and re-aspirating the droplet into the collection tube; and subjecting the concentrated sample to a detector for analysis.

In accordance with another aspect of the present invention, there is provided a method for concentrating a liquid sample, including: providing a collection tube open at each end; partially filling the collection tube with liquid sample such that the liquid sample is collected at one end of the tube and forming a plug of liquid sample extending from the filled end of the tube to a location within the non-filled portion of the tube; exposing each end of the tube to the surrounding environment; and drying the sample such that the evaporation rate of the portion of the liquid plug nearest the filled end of the tube is greater than the evaporation rate of the portion of the liquid plug nearest the non-filled end of the tube, causing the sample to concentrate at the filled end of the tube.

These and other aspects of the present invention will become apparent upon a review of the following detailed description and the claims appended thereto.

### BRIEF DESCRIPTION OF THE DRAWINGS

FIGS. 1A and B: (A) shows droplet formation of nanoLC fraction effluent at the end of a capillary column inserted through and extending beyond the end of a pipette tip; (B) shows capture of the effluent droplet at the end of the pipette tip after capillary retraction, in accordance with the present invention.

FIGS. 1C and D: (C) shows collection of nanoLC fraction effluent into a pipette tip from a partially inserted capillary having a relatively small outer diameter (“OD”); (D) shows capture of the effluent fraction in the pipette tip end after capillary retraction, in accordance with the present invention.

FIG. 2 shows a bar graph of peptide concentration verses signal intensity for adsorptive loss studies of Bradykinin (A), Angiotensin I (B), and Insulin (C) collection in accordance with the present invention.

FIG. 3(A) is a photograph of a pipette tip containing a reconstituted dried nanoLC fraction; (B) is a photograph of the pipette tip containing the reconstituted fraction shown in (A) following concentration by three dispense-delay-aspirate steps where the sample is exposed to atmosphere in accordance with the present invention.

FIG. 4 shows single ion chromatograms of the various phosphorylation states of the two known phosphopeptides of Fetuin. (A) shows the first phosphopeptide, Ser138, and a missed tryptic cleavage (B). (C) shows the second phosphopeptide of fetuin having three known phosphorylation sites (Ser320, Ser323, and Ser324).

FIGS. 5(A-D) show the ion current of sample fractions reconstituted in various solvents in accordance with the present invention.

FIGS. 6(A-B) show data (mass spectrum) from the traditional online nanoLC experiment (A) vs. the collected fraction that had been reconstituted in a preferred ionization solvent and extended MS analysis time (B). This preferred ionization solvent and extended analysis time allowed for more diagnostic ions to be identified as well as superior spectral data quality.

FIG. 7 shows identification of the triply phosphorylated peptide, 313-HTFSGVApSVEpSpSSGEAFHVGK-333 in the fraction in accordance with the present invention.

FIG. 8(A) shows a single scan spectrum of an unphosphorylated fetuin peptide; (B) shows signal averaging for the fraction containing the peptide shown in (A).

FIG. 9(A) shows a nanoLC chromatogram of 100 fmol of RNase B tryptic digest; (B) shows the full scan MS spectrum from tip #2 shown in FIG. 9A.

FIGS. 10(A-D) show tandem MS experiments results performed on tip #2 shown in FIG. 8(A).

FIG. 11 (A) is a photograph showing the concentration and mixing of a sample by liquid aspiration and droplet expulsion, respectively; (B) is a photograph showing the concentration result after several cycles of the droplet expel and aspiration cycles.

FIG. 12 is a photograph showing a 25 nL volume of sample collected in a capillary in accordance with the present invention.

FIG. 13 is a series of photographs showing the collection of a sample in a capillary with the formation of a sample droplet protruding from the end of the capillary and the captured droplet following withdrawal of the capillary.

FIG. 14 is a series of photographs showing 10 μL of a fluorescent dye drying down in the end of a pipette tip.

### DETAILED DESCRIPTION OF PREFERRED EMBODIMENTS

The present invention relates to methods for low-volume fraction collection and sample concentration, preferably from a liquid chromatography fraction, and for detection, e.g. electrospray ionization of the fraction, preferably by mass spectrometry. The invention is useful for proteomic, small molecule, and life science applications and decouples liquid chromatography and mass spectrometry solvent requirements, while extending MS analysis time per fraction.

The method includes collecting, from a deposition device, a low volume liquid sample within a low volume fraction collection device. The deposition device and collection device, are each preferably a tube. As used herein, the term tube refers to a hollow cylinder-like substrate which can have a circular or non-circular cross-section. A collection tube suitable for use in the present invention includes any liquid collection tube having an inner diameter or shape of a size sufficient to retain liquid by capillary action. Examples of suitable collection tubes include a, pipette tip, capillary tube, cylinder, and the like. Preferably the collection tube is tapered. By way of example, a pipette tip will be used in the present description to represent the collection device of the present invention. A deposition device suitable for use in the present invention includes any liquid delivery tube having an outer diameter or shape of a size sufficient to be inserted in the collection device. Examples of suitable delivery tubes include a, capillary column, capillary tube, cylinder, non-cylindrical tube, and the like. By way of example, a capillary tube will be used in the present description to represent the deposition device of the present invention.

In accordance with the invention, a sample is collected by placing a capillary tube within the pipette tip so that the tip of the capillary tube protrudes out of the tip of the tapered end of the pipette tip. Liquid sample, preferably from an LC column containing solvent and an analyte, is fed through the capillary tube to the tip of the capillary until a desired volume of sample forms a droplet at the end of the capillary tube. The capillary tube is then retracted within the pipette tip so that the sample droplet is collected within the end of the pipette tip.

In a further embodiment, sample collection involves inserting the liquid deposition device into the tapered end of a pipette tip such that the deposition device is either protruding from the opposite end of the pipette tip, or alternatively is positioned in the interior of the pipette tip. A liquid droplet is allowed to form on the end of the liquid deposition device, and after a user-defined period of time, the liquid deposition device is retracted from the pipette tip, collecting a liquid sample in the end of the pipette tip. Insertion and retraction of the liquid deposition device occurs from the same tapered end of the pipette tip.

In another embodiment, sample collection involves inserting the liquid deposition device into the tapered end of a pipette tip such that the deposition device is nearly co-planar or slightly recessed with the tapered end of the pipette tip. A liquid droplet is allowed to form on the end of the liquid deposition device, and after a user-defined period of time, the liquid deposition device is retracted from the pipette tip, collecting a liquid sample in the end of the pipette tip. Alternatively, the liquid sample is fed through the deposition device out the tip of the deposition device until a desired volume of sample collects within the end of the pipette tip. Insertion and retraction of the liquid deposition device occurs from the same tapered end of the pipette tip.

In another embodiment, depending upon the volume of sample desired, a deposition device, e.g., capillary tube, having a relatively small outer diameter as compared to the inner diameter of the pipette tip is positioned within the pipette tip so that the tip of the capillary tube is in a retracted or near co-planar position relative to the end of the pipette tip. The liquid sample is fed through the capillary tube out the tip of the capillary until a desired volume of sample collects within the end of the pipette tip. The capillary tube is then retracted completely from within the pipette tip without substantially disturbing the sample collected in the end of the pipette tip. In a further embodiment, the capillary tube is withdrawn continuously as the liquid sample is being fed through the capillary, so as to maintain the dispensing end of the capillary at or above the rising level of the liquid sample being collected in the pipette tip.

Once collected in the pipette tip, the sample is ready for detection. The sample can be dried. This can be done by allowing the sample to dry passively or by drying the sample by methods known in the art. These methods include applying heat, positive pressure, or negative pressure, flowing gas across the end of the pipette tip, and the like, to the sample to evaporate the solvent. Typically, the chromatography solvent is substantially removed from the analyte when the sample is taken down to dryness.

The sample is then prepared for analysis, for example by MS, by choosing the desired solvent. The desired solvent is aspirated into the pipette tip to reconstitute the dried sample.

Preferably, the reconstituted sample is mixed and concentrated by exposing the sample to a desired number of cycles of expelling the sample and forming a droplet at the end of the pipette tip, exposing the expelled droplet to the atmosphere, and re-aspirating the droplet into the pipette tip until the desired amount of mixing or mixing and concentrating of the sample is achieved.

The sample is then subjected to a detector for analysis. Preferably the sample is injected into the detector by use of electrospray, preferably nanoelectrospray. Examples of suitable detectors include atmospheric pressure ionization or matrix assisted laser adsorption ionization mass spectrometers such as linear and three-dimensional ion traps, fourier transform, and quadrapole-based instruments as well as spectrophotometer, laser fluorimeter, radio active detectors, infra-red detectors, and ionization based detectors.

In a further embodiment, larger volumes may be collected and dried down to smaller volumes (or dried completely) followed by reconstitution in a much smaller volume than the initial collection volume, thus yielding sample concentration.

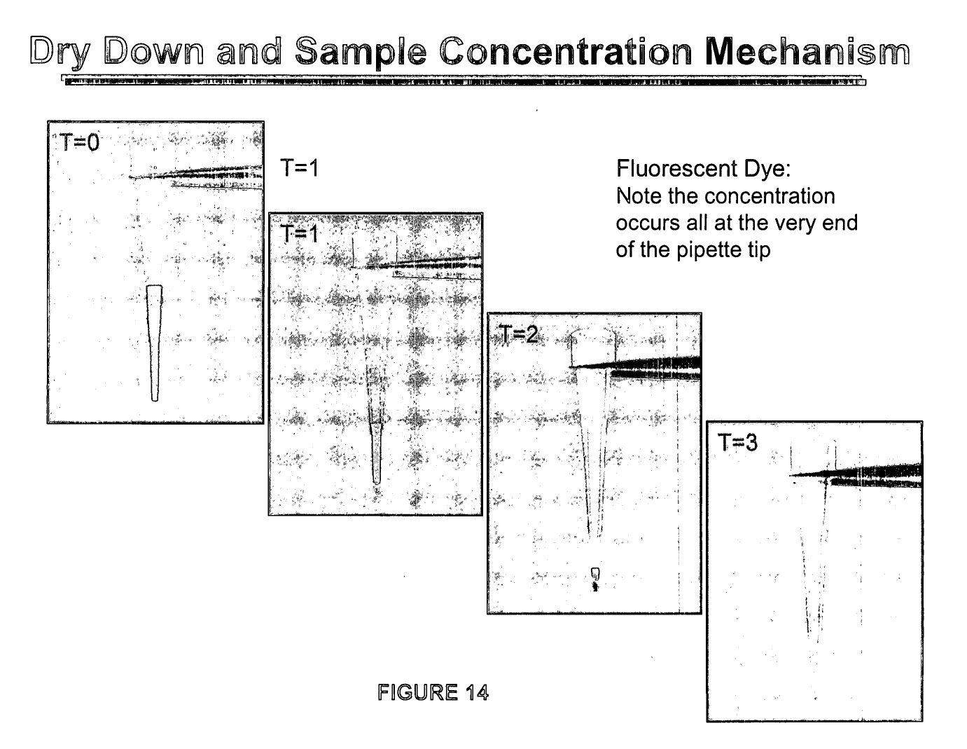

In accordance with the present invention, LC fractions can be collected in nanoliter volumes, preferably from about 1 to about 1000 nL in volume, and up to about 25,000 nL in volume. LC fractions are collected into pipette tips from a small column, preferably about 75 to about 320 μm nanoLC columns, at a user-defined timed-interval, typically one fraction every 3 to 600 seconds. The solvent in each tip is dried, preferably by allowing the solvent to evaporate to dryness. Most preferably, the fractions in the pipette tip are permitted to dry down naturally on their own in accordance with the present invention to create a concentrated band at the very end of the interior of the pipette tip. Such a procedure is shown in FIG. 14 where 10 μL of a fluorescent dye was allowed to dry in a pipette tip. Insets at Time=0, 1, 2, and 3 are provided to illustrate the time course of the dry-down. The increasing intensity of the dye at the end of the tip demonstrates the fact that the sample is concentrated at the very end of the pipette tip.

Once dried, the sample in each tip can be reconstituted, for example, in 200 to 300 nL of optimal ionization solvent, thereby rendering the choice of chromatography solvent independent from the choice of analysis solvent. As the chromatography and reconstitution solvent choice are independent, the reconstitution solvent can be subsequently selected to maximize ionization efficiency without compromising the previous chromatography separation. Furthermore, the fractions are collected, reconstituted, and analyzed directly in the pipette tip, eliminating the need for an intermediate collection substrate and subsequent injection hardware, such as valves and tubing.

The reconstitution includes aspirating the desired reconstitution solvent. In one embodiment, the sample is then subjected to multiple cycles of expelling the sample from the pipette tip to form a droplet which hangs on the exterior of the tip, a delay of several seconds, and then re-aspirating the droplet into the pipette tip. These dispense/delay/aspirate cycles achieve a sufficient reconstitution due to both sample agitation, as well as sample evaporation which leads to concentration of the sample. Alternatively, in another embodiment the reconstitution includes first aspirating the desired reconstitution solvent. Then the sample is reconstituted and mixed by gentle agitation within the pipette tip, including repeated cycles of aspiration and dispense, such that the sample always remains within the pipette tip. Yet another embodiment for reconstituting the dried sample in the pipette tip includes, aspirating the reconstitution solvent and holding the solvent within the tip, preferably, without agitation, for a user specified amount of time.

Several methods of analysis of the reconstituted sample are available. Firstly, the entire sample volume is consumed in analysis. Secondly, only a portion of the sample is consumed in analysis, and then an additional solvent is aspirated into the pipette tip, the sample is mixed by gentle agitation within the pipette tip or can be mixed, evaporated down, and concentrated using the method of expelling a droplet from the pipette tip discussed above, and then the sample is re-analyzed. The solvents used can contain additives and be customized for optimal analysis, and they can also contain analytes to create chemistries with the sample within the pipette tip. And finally thirdly, only a portion of the sample is consumed in analysis, and then the remaining sample is allowed to go to dryness in the pipette tip. An additional solvent is aspirated into the pipette tip, the sample can be mixed, evaporated down, and concentrated using the method of expelling a droplet from the pipette tip discussed above, and then the sample is re-analyzed. The solvents used can contain additives and be customized for optimal analysis, and they can also contain analytes to create chemistries with the sample within the pipette tip. Further, different solvents can be used each time depending upon the desired analysis solvent.

Reconstituted fractions can be analyzed for example, using infusion with an electrospray emitter, for example, pulled capillaries or electrospray ionization chip technology, such as the ESI Chip™, commercially available from Advion BioSciences (Ithaca, N.Y.). Preferably, a low flow ESI Chip is used which includes 400 nozzles each with an inner diameter of 2.5 μm and yielding flow rates of approximately 20 nL/min, permitting at least 10 minutes of analysis time per fraction. Alternatively, a non chip-based nanoelectrospray emitter could be implemented. As LC fractions are typically collected every 60 seconds, a significant gain in analysis time is achieved. The utility of this approach is demonstrated below using fetuin tryptic digest in a phosphorylation analysis and RNase B tryptic digest in a glycosylation analysis. Therefore, for example, when reconstituted in 250 nL, each nanoLC fraction can be analyzed for over ten minutes. This increase in analysis time allows for signal averaging resulting in higher data quality, collision energy optimization, slower scanning techniques to be used such as neutral loss and precursor ion scanning, higher resolution scans on FTMS instruments, and improved peptide quantitation. Furthermore, the nanoLC fractions could be optionally archived in the pipette tips for analysis at a later date.

Alternately, the drying step is optional, and the collected sample can be analyzed at the same concentration it is collected or at an increased concentration of the sample, if desired. Typically, this procedure is used when the sample is collected in a solvent which is the analysis solvent of choice or which does not substantially interfere with the analysis desired. In another embodiment, a liquid containing additives is aspirated in order to enhance ionization prior to analysis. Further, additives can be used which allow for in-tip chemistry to occur prior to detection. For example, a strong acid or base, metal such as a chelator may be added to enhance ionization or to form a complex.

A collection and analysis system suitable for use in accordance with the methods disclosed herein for collecting ultra-low volume fractions includes robotics that manipulates a deposition device that fractionates a liquid stream and deposits the liquid in a collection device capable of handling nanoliter amounts utilizing capillary forces. Following the collection, the fractions are directly manipulated in the collection device. According to the present invention, the sample can be concentrated or reconstituted in a new solvent system prior to analysis, by for example, electrospray ionization mass spectrometry. Suitable systems include the nano Fraction Analysis Chip Technology (“nanoFACT”), commercially available from Advion BioSciences (Ithaca, N.Y.). NanoFACT enables collecting fractions of an effluent or sample stream and their subsequent analysis. Alternative steps and procedures can include fraction dry down or concentration as well as reconstitution involving customized solvents and volumes allowing for sample concentration. NanoFACT provides ultra-low volume fraction collection directly from nanoLC columns over the course of a chromatographic run. Fractions as small as about 1 nL are collected in an automated, reproducible fashion into pipette tips using automated nanoelectrospray robotics, such as NanoMate technology. In accordance with this technology, a robotic system manipulates liquids via a pipette tip followed by positioning the tip and delivery of the liquid via pressure and voltage to an electrospray ionization chip. These fractions are collected based on a user-defined time interval and can range from 100% aqueous to 100% organic, spanning the chromatographic window of interest where peptides elute.

The advantages of nanoFACT are shown for phosphorylation analysis using bovine fetuin and glycosylation analysis using bovine ribonuclease B (RNase B). In the phosphorylation analysis, a comparison between conventional nanoLC and a nanoFACT analysis was performed. An MS/MS spectrum of a triply phosphorylated peptide, 313-HTFSGVApSVEpSpSSGEAFHVGK-333 was obtained using nanoFACT but not using nanoLC. Furthermore, spectra quality for the nanoFACT analysis was significantly improved over nanoLC. This was determined by comparing the number of diagnostic ions between the nanoFACT and nanoLC spectra and it was found that the nanoFACT spectra contained 19% or greater number of diagnostic ions for non-phosphorylated peptides and 55% or greater for phosphorylated peptides. For the glycosylation analysis, the glycosylation site of RNase B was fully characterized using 100 fmol of tryptic digest on an LCQ Deca XP three-dimensional ion trap mass spectrometer.

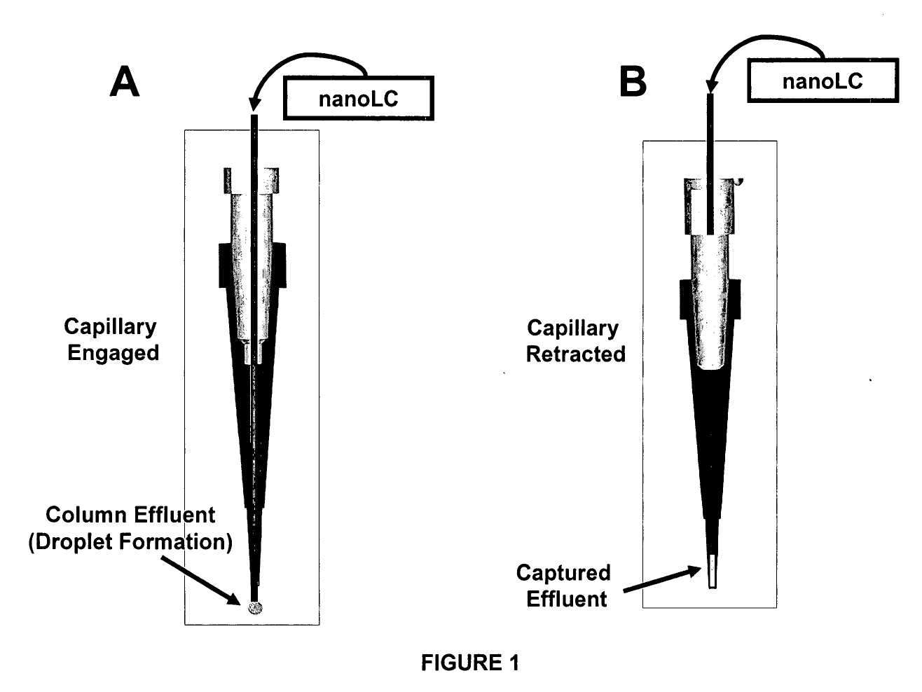

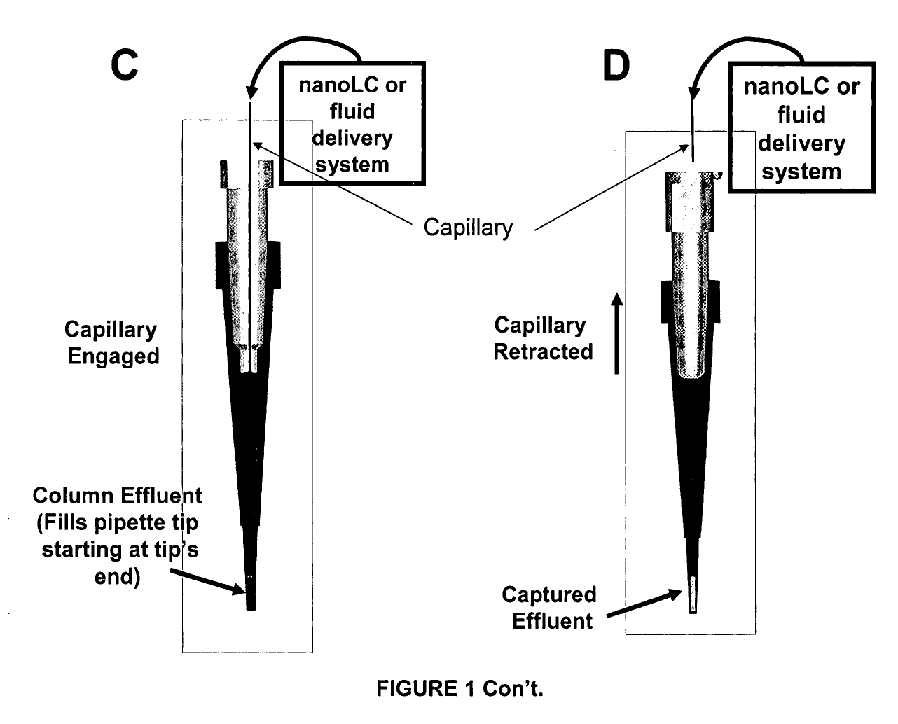

FIG. 1A shows a capillary from the end of a nanoLC column protruding from the end of a pipette tip. The droplet of nanoLC column effluent builds until the pre-defined fraction collection time interval has been reached. FIG. 1B shows the fused silica column after it has been quickly retracted and the effluent is captured in the end of the pipette tip. The capillary is quickly withdrawn from the pipette tip and inserted into the next pipette, leaving a plug of nanoLC effluent inside the original pipette tip, as shown in FIG. 1B. Smaller fractions may be collected if a smaller pipette inner diameter (“ID”) and architecture are used.

Once collected, the nanoLC fractions preferably are permitted to dry down naturally on their own without any intervention, within approximately 10 minutes depending on the solvent composition. The manner in which the tips dry is highly reproducible and is independent of solvent composition. This dry down process results in the sample evaporating down to the very end of the pipette tip, leaving a highly concentrated ring of analyte at the interior base of the tip. Alternately, the evaporation rate can be accelerated by various methods which include subjecting the droplet to, a vacuum, positive or negative pressure, a pure gas, or mixture of two or more gaseous components or compounds, or through temperature control.

FIG. 1C shows a nanoLC fraction collected into a pipette tip using a small outer diameter (“OD”) capillary (less than 90 micron). This tubing or column tail is positioned at the pipette tip end (approximately flush) by a robotic positioning system, such as a NanoMate™, commercially available from Advion BioSciences (Ithaca, N.Y.). This small OD capillary is especially important for nanoliter range collections. As liquid exits the capillary, the liquid collects in the pipette tip end. FIG. 1D shows the fused silica column after it is quickly retracted once the desired volume is collected and the effluent is left at the end of the pipette tip. The effluent remains in the pipette tip end due to the capillaries' relatively small diameter. This approach where the liquid exits directly into the tip limits evaporation during the collection and enables the collection of from as little as a few nanoliters to as much as microliter collection volumes. For larger volume collections, such as those greater than a microliter, an alternate procedure can be used where the capillary tube is inserted into the pipette until it is approximately flush with the pipette tip and then upon filling the capillary is elevated with the level of the liquid so only the capillary end is in contact with the rising liquid. When the desired volume is reached the capillary is completely retracted prior to capillary placement in the next tip.

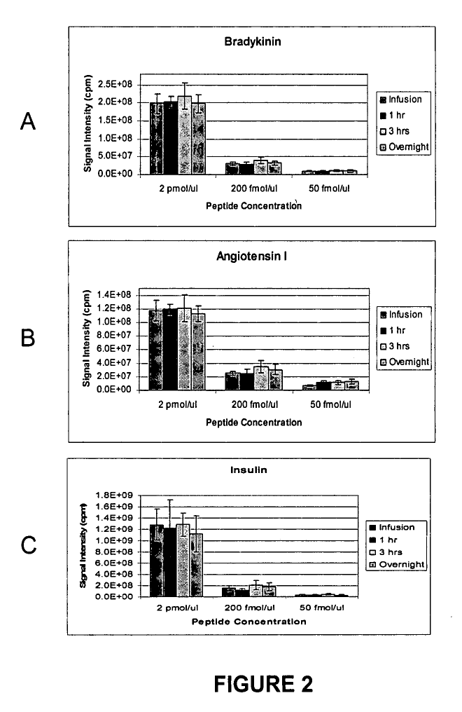

It should be noted that the substrate material of the collection tube or exposed surfaces in the collection device is preferably chemically compatible with the analytes of interest. For example, when samples are susceptible to adsorptive loss, an inert material can be implemented to mask the native substrate material of the collection tube. Several adsorptive loss studies using peptides Bradykinin, Angiotensin, and Insulin have been performed and have shown no adsorptive loss to occur, as shown in FIGS. 2A, 2B, and 2C. This is due to the fact that the pipette tips used for the collection are preferably coated with a material which is inert to the sample, preventing adsorptive loss. Additional studies were performed using peptides known to be particularly sticky, but no adsorptive losses were observed. FIG. 2 shows adsorptive loss studies for Bradykinin (A), Angiotensin I (B), and Insulin (C). A solution of each peptide at 2 pmol/μL, 200 fmol/μL, and 50 fmol/μL was aspirated into a pipette tip and dried. The pipette tips were reconstituted and analyzed after being in the tip 1 hour, 3 hours, and overnight. The signal intensities were compared to those obtained from a direct infusion as a measure of adsorptive loss. No adsorptive losses were detected.

Alternatively, the substrate material of the collection tube or exposed surfaces in the collection device could be altered in order to selectively react or bind with the sample of interest. This functions to fractionate or simplify the collected fractions. For example, chemical surfaces and biochemical surfaces can be used. These include, for example, stationary phases such as reversed-phase coatings, e.g., (C4 to C18), normal phase, affinity coatings, cation/anion exchange, antibodies, ligand binding, tags such as immobilized metal affinity chromatography (IMAC), hydrophobic or hydrophilic, ionic, DNA, or enzyme, which can be used for selective binding of the target analytes.

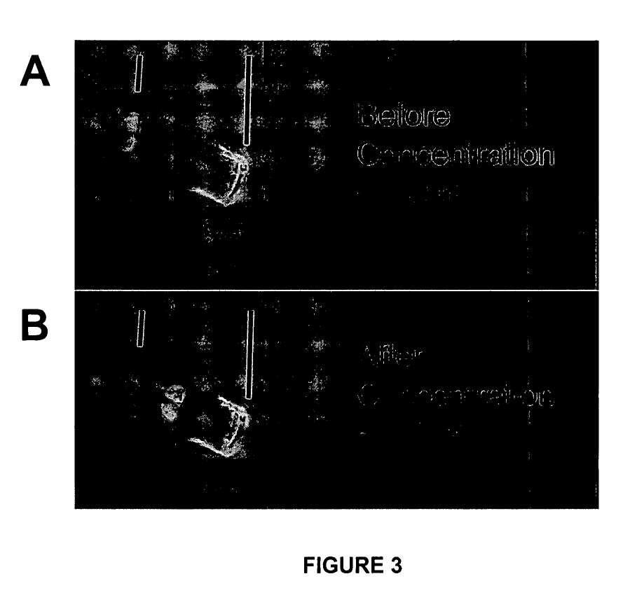

Following collection and subsequent dry-down, the sample is reconstituted directly in the pipette tip and preferably analyzed immediately. The reconstitution process is preferably also fully automated and includes aspirating reconstitution solvent from a well plate using the NanoMate. Preferably, one would reconstitute the nanoLC fraction in the pipette tip in low submicroliter volumes of solvent to minimize dilution effects. However, these very low volumes are more difficult to aspirate in a reproducible fashion. Therefore, a typical aspiration volume used in such a reconstitution process is about 500 nL, and evaporation is used to reduce this volume to a desirable range of for example, about 200 to about 300 nL. Following aspiration, the reconstitution solvent in the tip is dispensed, forming a hanging droplet on the exterior of the tip. After a user-defined delay time, the droplet is then aspirated back into the pipette tip. This well-controlled dispense-delay-aspirate cycle is typically repeated three times, but may be done more or less times depending upon the desired final concentration. There are two advantages derived from performing the reconstitution step in this manner. The first relates to when the droplet is exposed to the atmosphere, evaporation readily takes place. FIG. 3A shows the end of a pipette tip immediately following aspiration of 500 nL of reconstitution solvent to reconstitute the dried nanoLC fraction in the pipette tip. The 500 nL of reconstitution solvent was aspirated from a microtiter well-plate using the NanoMate. FIG. 3B shows the pipette tip of FIG. 3A after three dispense-delay-aspirate cycles have been performed where the solvent is exposed to atmosphere, evaporation results in a final reconstitution volume of solvent remaining in the tip of approximately 250 nL. Further dispense-delay-aspirate cycles can be repeated when a smaller volume is desired. Therefore, these dispense-delay-aspirate cycles allow the reconstitution of the nanoLC fraction in low volumes that would not otherwise be possible due to limitations of standard laboratory robotics. The second advantage relates to using these cycles in the reconstitution step is to generate agitation between the solvent and the tip wall to maximize dissolution of the previously dried fraction. By expelling the droplet in this manner adsorptive losses to the tip walls would be minimized due to the limited contact of the sample to the tip wall surface, versus generating agitation by pulling the sample further up inside the tip, which may result in adsorptive losses to the tip walls.

By performing the reconstitution with dispense-delay-aspirate cycles, evaporation enables the initial reconstitution solvent aspirated to be different than the concentration or composition of the final analysis solvent. Therefore, a reconstitution solvent is selected that contains a higher percentage of organic than is desired for the analysis, such that following the dispense-delay-aspirate cycles, evaporation will create the desired analysis solvent composition.

Following reconstitution, the nanoLC fraction is preferably immediately analyzed using nanoelectrospray mass spectrometry, preferably with an ESI Chip, such as one containing 400 nozzles, each having a 2.5 μm inner diameter. The flow rate achieved with this low-flow ESI Chip is 20 nL/min, providing at least 10 minutes of analysis time per nanoLC fraction collected. Alternatively, a similar flow rate, non chip-based nanoelectrospray emmiter could be used.

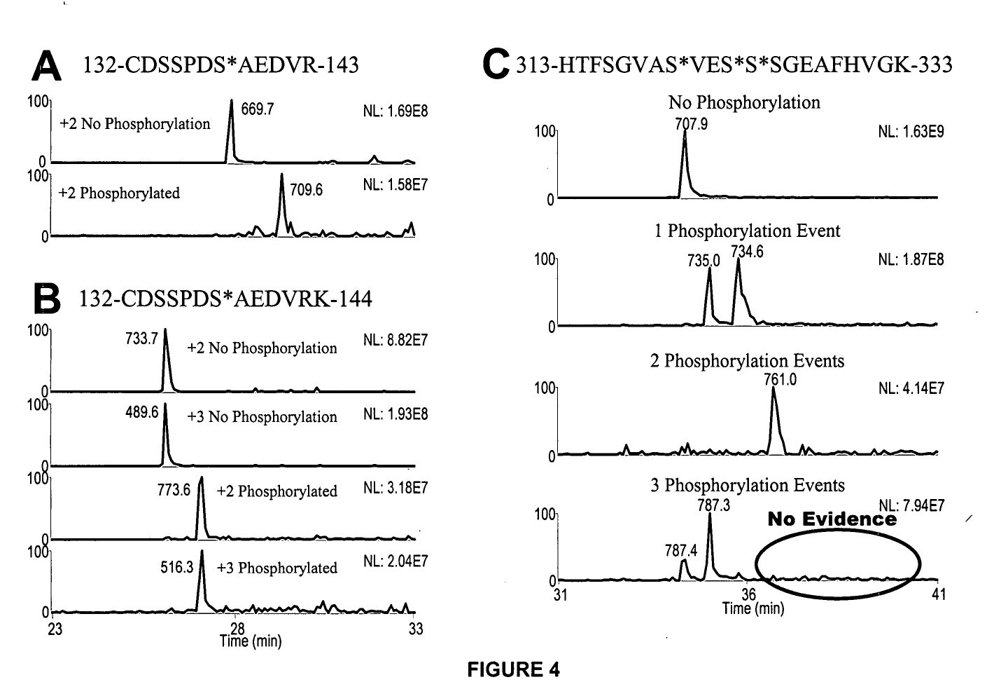

In FIG. 4, fetuin has two known phosphopeptides for which the single ion chromatograms of the various phosphorylation states of these phosphopeptides are plotted. Shown in FIG. 4(A) for the first phosphopeptide, Ser138, two peptides are observed due to a missed tryptic cleavage (B). (C) The second phosphopeptide of fetuin has three known phosphorylation sites (Ser320, Ser323, and Ser324). Peptides containing 0, 1, and 2 phosphorylation events at these sites were identified by nanoLC, however, no triply phosphorylated peptide was observed.

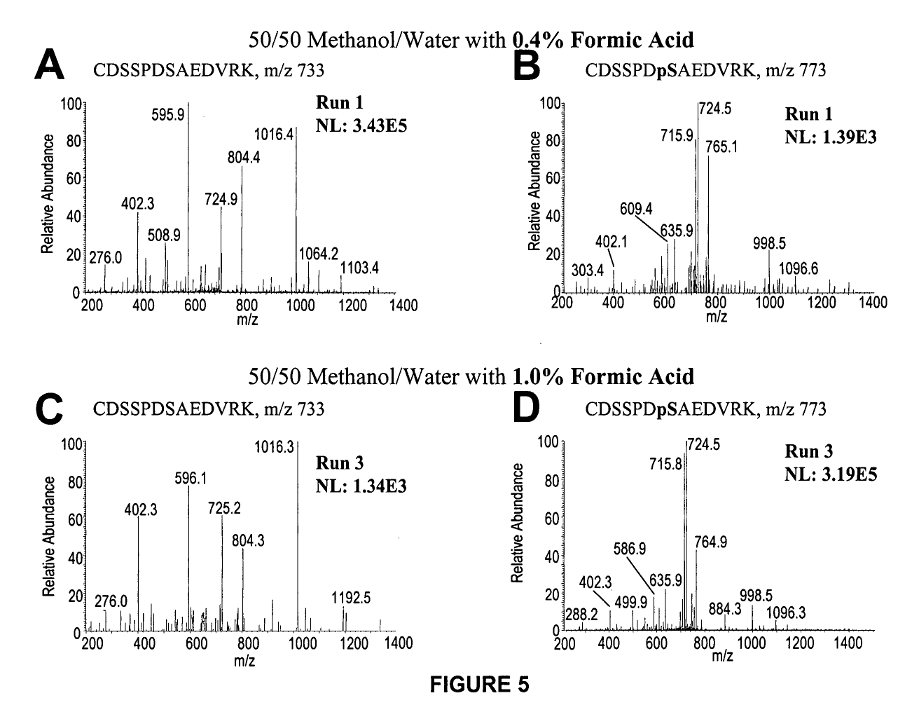

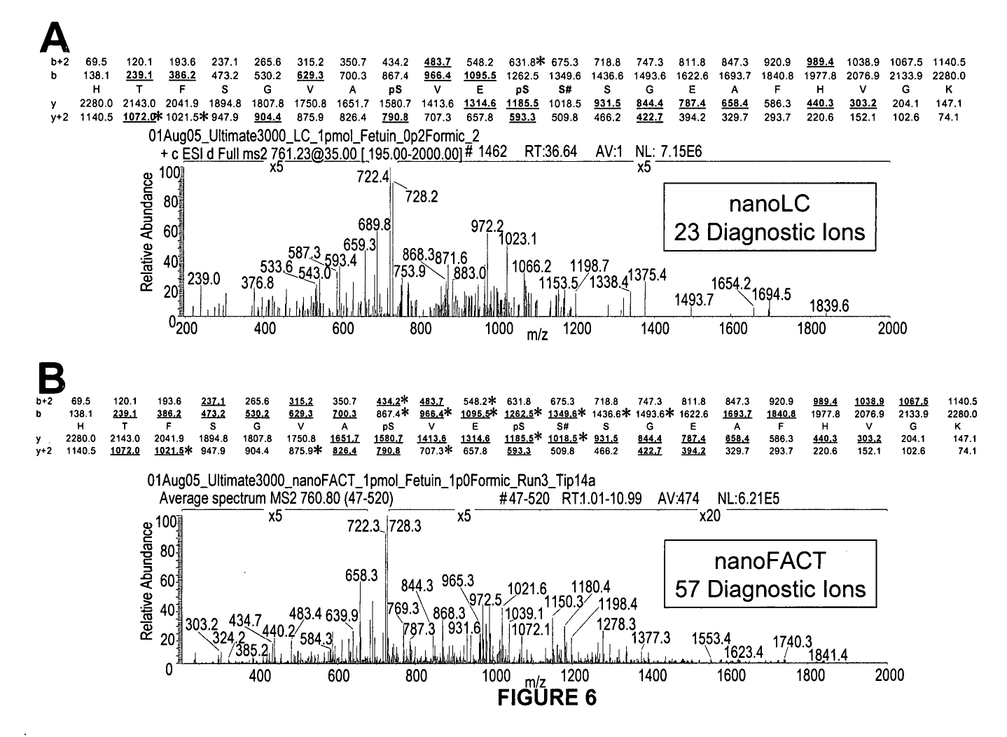

FIG. 5 shows sample fractions collected into pipette tips, dried, and reconstituted in 50/50 methanol/water with 0.4% formic acid. The ion current for 2 minutes of averaged MS/MS data for the fragment ions for the unphosphorylated peptide (A) with m/z 733 was 3.43e5. Whereas, the MS/MS ion current for the phosphorylated peptide (B) with m/z 773 reconstituted in the same solvent mixture had an ion current of only 1.39e3. When the reconstitution solvent mixture was changed to 50/50 methanol/water with 1.0% formic acid, the ion current for the unphosphorylated peptide, m/z 733 (C) decreased to 1.34e3. However, the ion current for the phosphorylated peptide, m/z 773 (D) increased to 3.19e5. These results demonstrate that the choice of reconstitution solvent can have a large effect on ionization efficiency.

FIGS. 6(A-B) show data (mass spectrum) from the traditional online nanoLC experiment (A) vs. the collected fraction that had been reconstituted in a preferred ionization solvent with an extended MS analysis time (B). This preferred ionization solvent and extended analysis time allowed for more diagnostic ions to be identified as well as superior spectral data quality. In FIG. 6, (A) using a data dependent acquisition method only a single MS/MS spectrum was obtained for the doubly phosphorylated peptide from fetuin. The spectrum contained 23 diagnostic ions, with evidence for a mixture of phosphorylation at Ser320, Ser323, and Ser324. (B) By collecting nanoLC fractions into pipette tips using nanoFACT, a 1 minute nanoLC fraction was reconstituted and infused for approximately 11 minutes. Signal averaging resulted in improved data quality. For this peptide, 11 minutes of data averaging increased the number of diagnostic ions to 57.

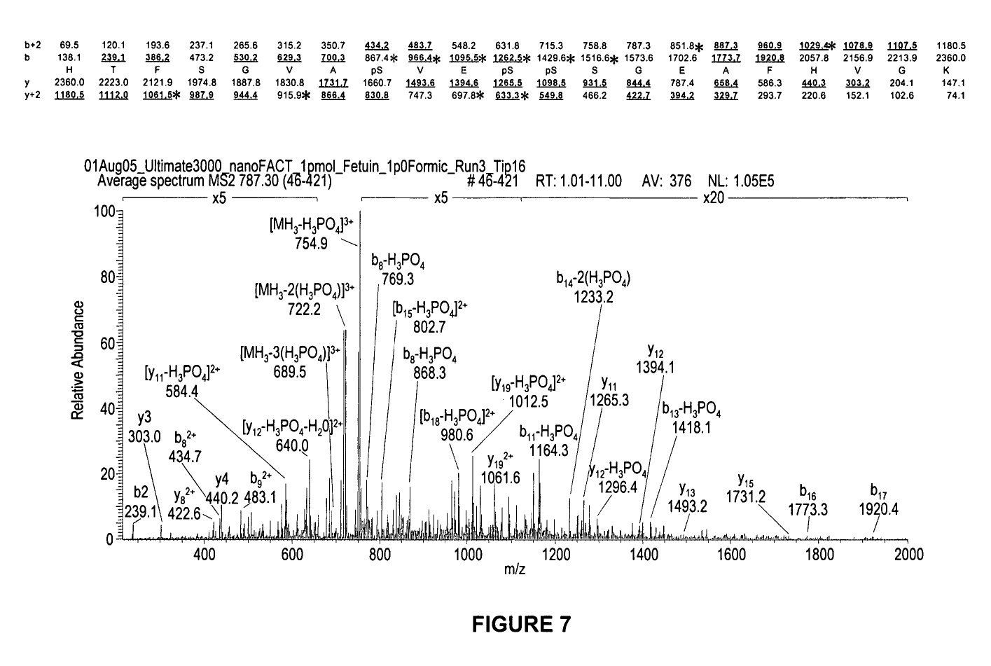

In FIG. 7 the fraction corresponding to the expected retention time of the triply phosphorylated peptide, 313-HTFSGVApSVEpSpSSGEAFHVGK-333, m/z 787, was reconstituted in 50% methanol in water with 1.0% formic acid and infused. Using nanoFACT, the triply phosphorylated peptide was unambiguously identified in the fraction.

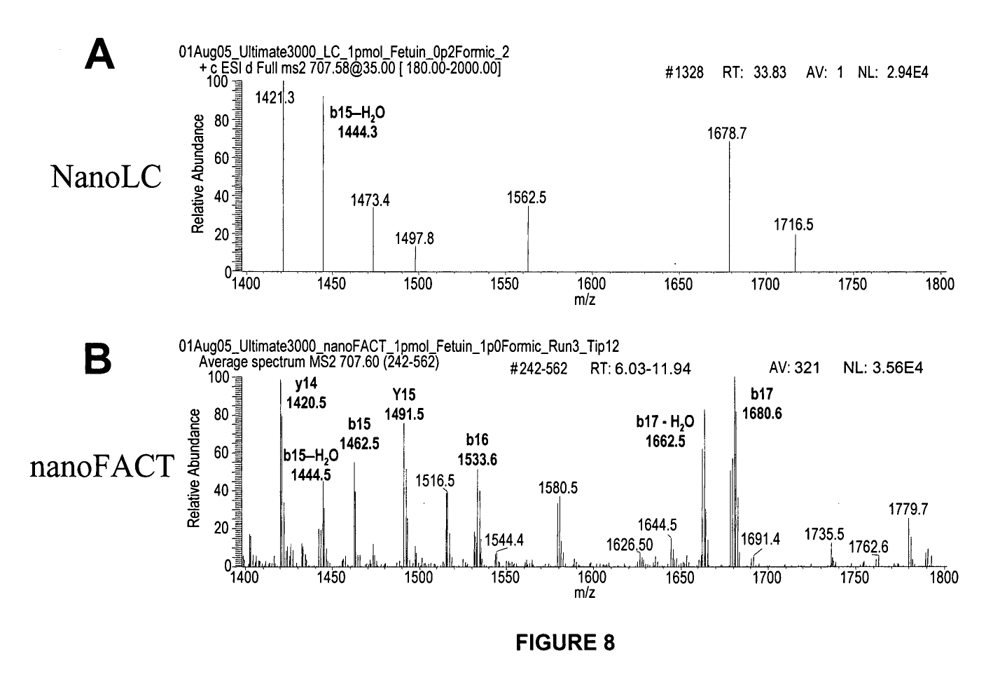

As shown in FIG. 8, (A) for a single scan spectrum of the unphosphorylated fetuin peptide, m/z 707, from nanoLC, few ions are observed above m/z 1400 for the peptide, and only one of which was a diagnostic ion for the peptide. (B) 6 minutes of signal averaging for the fraction containing the same m/z 707 peptide produced a higher quality spectrum with seven diagnostic ions identified.

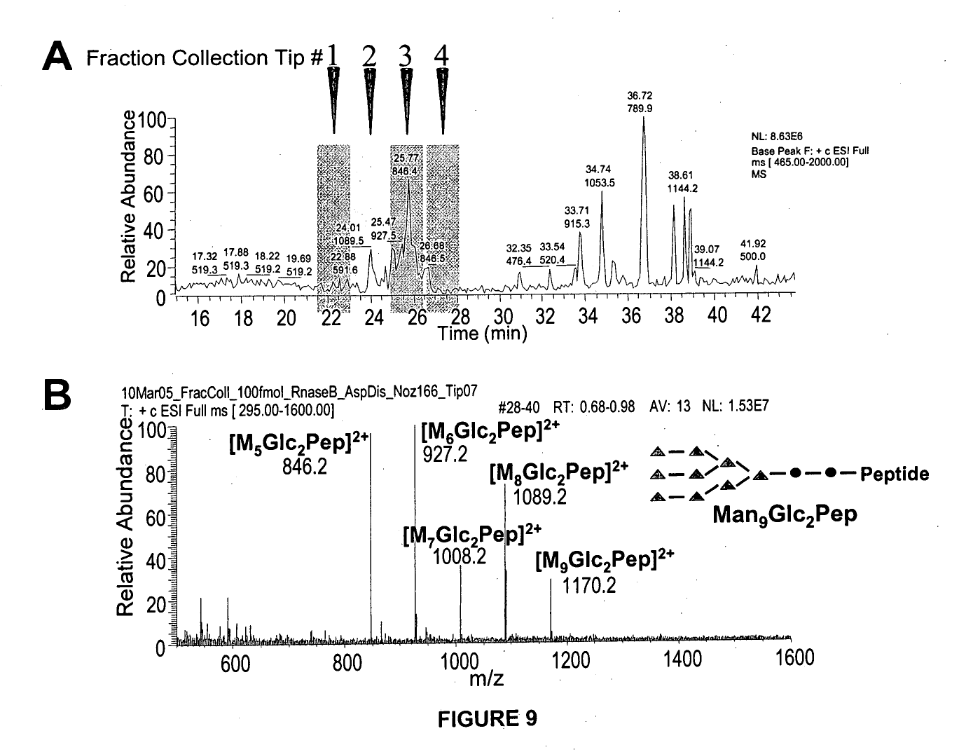

FIG. 9 (A) shows a nanoLC chromatogram of 100 fmol of RNase B tryptic digest. Four 90-second nanoLC fractions were collected in the ranges indicated, represented by tips # 1-4. Glycopeptides were found in tips # 2 and #3, but there was no evidence of them in tips #1 or #4, showing that the chromatography is preserved in the nanoLC fractions. (B) the full scan MS spectrum from tip #2 (shown in FIG. 9A) shows the presence of five glycopeptides in the nanoLC fraction, varying from five to nine mannose groups.

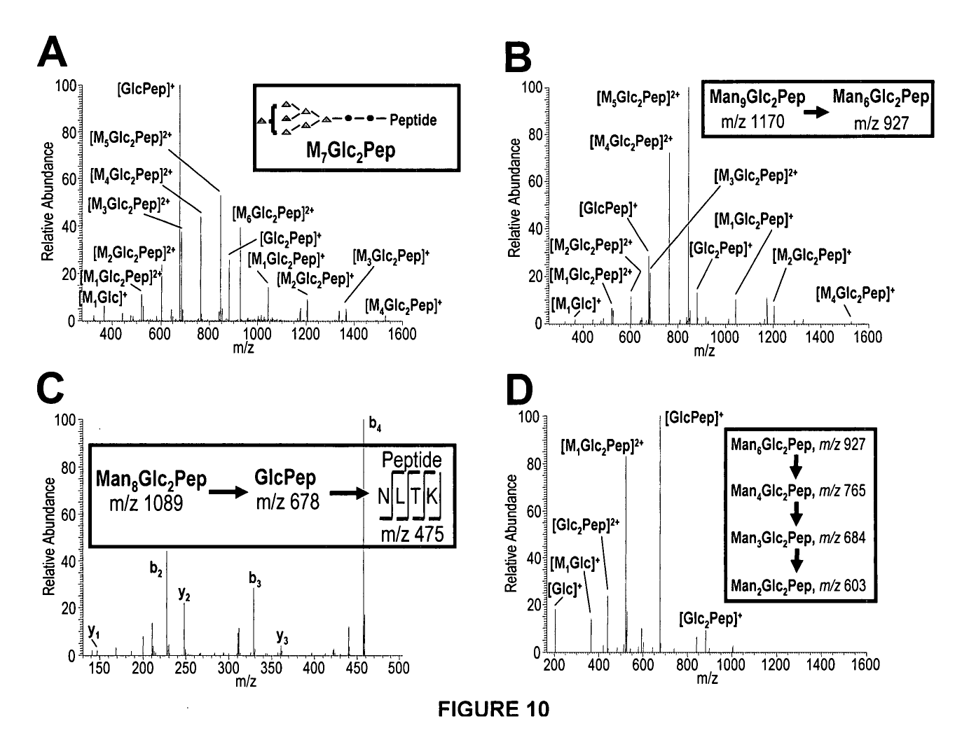

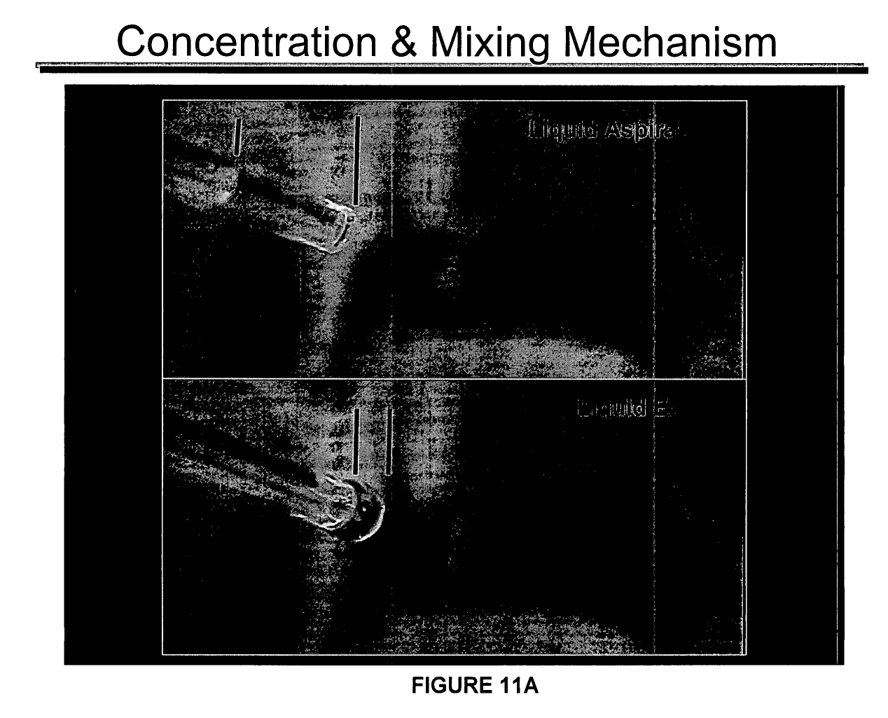

As shown in FIG. 10, tandem MS experiments were performed on tip #2 (shown in FIG. 8A). (A) MS² of m/z 1008. (B) MS³ of m/z 1170 to m/z 927. (C) MS⁴ of m/z 1089 to m/z 678 to m/z 475. The sequence of the glycosylated peptide was identified as NLTK. (D) MS⁵ of m/z 927 to m/z 765 to m/z 684 to m/z 603.

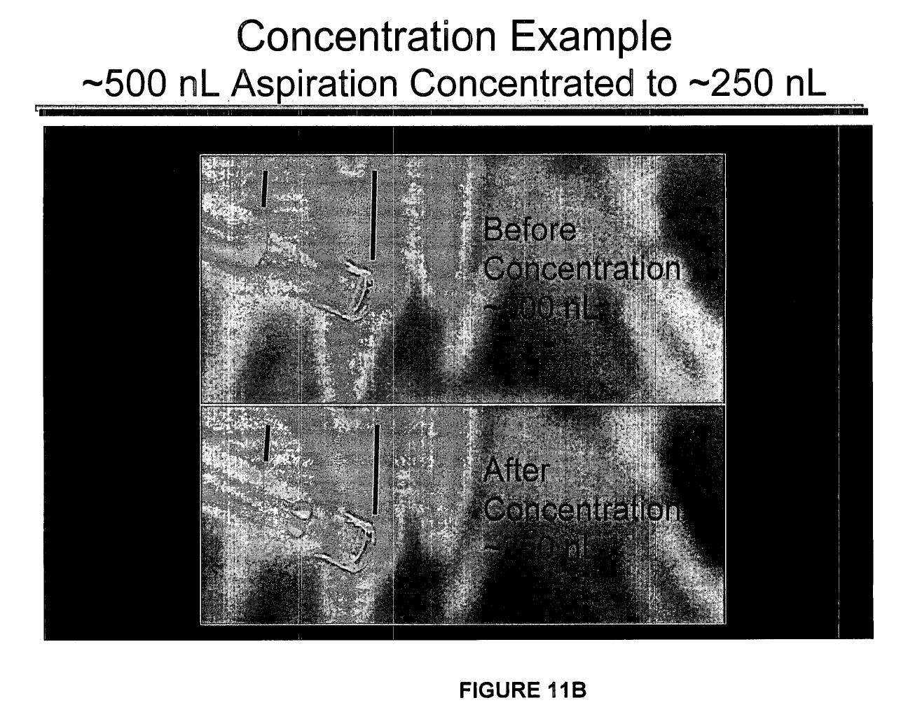

FIG. 11(A) shows the concentration and mixing of a sample by liquid aspiration and droplet expulsion, respectively. The droplet is exposed to the surrounding atmosphere. This process is able to be repeated depending on the amount of mixing and or concentration needed. FIG. 11(B) shows the concentration result after several cycles of the droplet expel and aspiration cycles. Here 500 nL was concentrated to 250 nL, however larger or smaller volumes can be similarly manipulated. After aspiration and concentration, re-aspiration of addition fluids, such as, for example solvents, may be conducted with further expel and droplet aspiration for mixing of one or more different liquid samples.

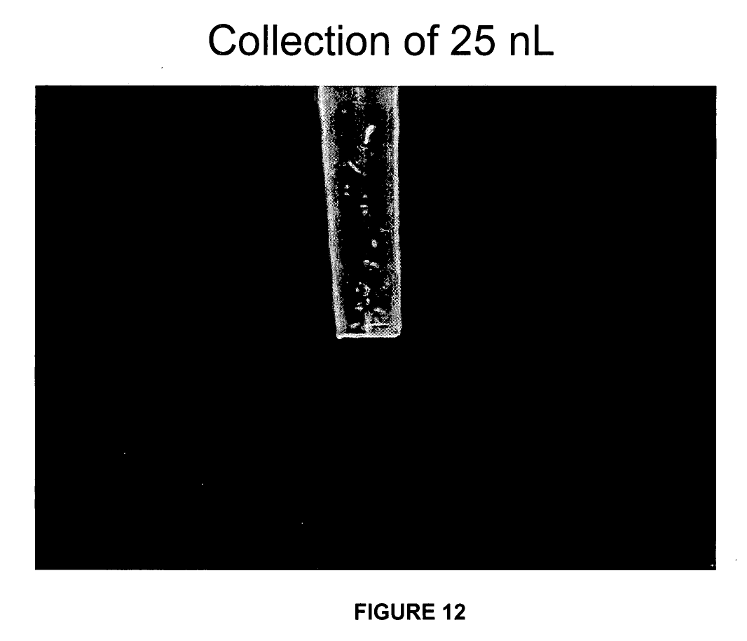

FIG. 12 shows a 25 nL volume of sample collected in a capillary in accordance with the present invention.

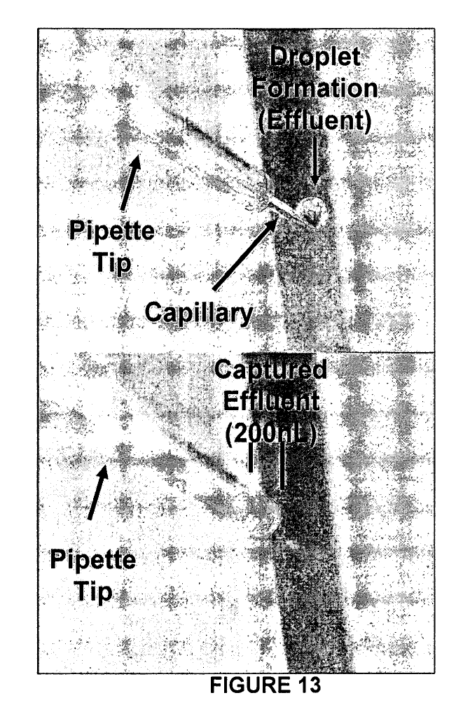

FIG. 13 shows the collection of a sample in a capillary with the formation of a sample droplet protruding from the end of the capillary. The capillary is withdrawn and the droplet is captured in the pipette tip. The captured effluent is allowed to dry to reduce volume.

FIG. 14 shows 10 μL of a fluorescent dye drying down in a pipette tip. The tip is shown at several time points over the course of the dry-down. The concentration of the sample occurs at the very end of the pipette tip, as can be seen from the increasing intensity of the dye at the end of the tip over the course of the experiment. The concentration of the sample at the end of the tip is an advantage as it allows for the sample to be reconstituted in a very low volume of solvent which is aspirated only at the very end of the pipette tip. In accordance with this embodiment of the present invention, a collection tube open at each end is partially filled with liquid sample such that the liquid sample is collected at one end of the tube forming a plug of liquid sample extending from the filled end of the tube to a location within the non-filled portion of the tube. The remaining portion of the non-filled end of the tube is thus empty of liquid. Each end of the tube is exposed to the surrounding environment. The evaporation rate of the portion of the liquid plug nearest the filled end of the tube is greater than the evaporation rate of the portion of the liquid plug nearest the non-filled end of the tube, which causes the sample to concentrate at the filled end of the tube. When taken to dryness, a concentrated band of sample is formed at what was formerly the fixed end of the tube. Thus, the dried sample can be reconstituted in a very small volume of liquid. Preferably, the evaporation is accelerated by passing an inert gas across the filled end of the tube.

The present invention enables the collection of ultra-low volume fractions. Such collection can be from a fluid delivery device operating in microliter per minute and nanoliter per minute flow ranges or directly from nanoLC columns over the course of a chromatographic run, e.g., about 75 μm, nanoLC columns. Typical fraction volumes collected in accordance with the present invention range from about 25 to about 25,000 nL. Fractions as small as about 25 nL can be collected in an automated, reproducible fashion into pipette tips. These samples can be further concentrated, resulting in sample volumes as low as from about 5 μL to about 25 nL. These fractions are collected based on a user-defined time interval and can range from 100% aqueous to 100% organic, spanning the chromatographic window of interest where peptides elute. FIG. 1A shows a capillary from the end of a nanoLC column protruding from the end of a pipette tip. The droplet of nanoLC column effluent builds until the pre-defined fraction collection time interval has been reached. Then the capillary is quickly withdrawn from the pipette tip and inserted into the next pipette, leaving a plug of nanoLC effluent inside the original pipette tip, as shown in FIG. 1B. Smaller fractions may be collected if a smaller pipette inner diameter (“ID”) and architecture are used. Once the fractions are collected, preferably they are permitted to dry down on their own, and then are reconstituted, preferably, immediately prior to infusion analysis. The final reconstitution volume is preferably adjusted to between about 200 to about 300 nL, which provides 10 to 15 minutes of analysis time using, for example, an ESI Chip with 2.5 μm inner diameter nozzles, flowing at 20 nL/min. When a lower flow rate nanospray device is used, correspondingly lower reconstitution volumes would be applicable.

The ability to collect a fraction from a nanoLC column every few seconds to tens of minutes, preferably 3 seconds to 10 minutes, and to then have 10 to 15 minutes to interrogate the sample is highly advantageous. The first advantage is that the present invention allows for choice of LC solvent and MS analysis solvent to be independent, permitting the enhancement of ionization without sacrificing chromatography. Organic-to-aqueous ratios and acid content can be modified in the reconstitution solvent to maximize ionization efficiency. One could also reconstitute the nanoLC fractions in a solvent conducive for negative ionization, so precursor ion scanning could be performed for phosphopeptide discovery. The second advantage offered by the present invention is longer analysis time per sample. It was shown that having the time to signal average provides higher data quality. Longer analysis time also allows for collision energy to be optimized. This is particularly advantageous when performing higher order tandem MS experiments and when trying to discern the amino acid sequence of a glycosylated peptide. Longer analysis times also allow for slower scanning modes to be used, such as neutral loss and precursor ion scanning, as well as using slower scans to gain higher resolution from Fourier transform mass spectrometry (“FTMS”) instruments. Another advantage of this invention is that by infusing a nanoLC fraction for analysis, a stable ion current is obtained compared to the analysis of the varying signal intensity of a chromatographic peak. This is potentially a large advantage for peptide quantitation studies. And finally, the present invention allows for nanoLC fractions to be optionally archived in the pipette tips and stored for analysis at a later date.

The examples illustrate the utility of the present invention for phosphorylation and glycosylation studies. In the phosphorylation analysis nanoFACT was able to obtain a high quality MS/MS spectrum for a triply phosphorylated peptide that was missed by a conventional on-line nanoLC experiment. Furthermore, a consistently greater number of diagnostic ions were observed in mass spectra generated by nanoFACT as compared to those generated by nanoLC for both non-phosphorylated and phosphorylated peptides. And finally a full glycosylation characterization was performed for RNase B.

The present methods are also capable of collecting larger volumes, e.g., about 1 to about 25 μL, from 100, 150, 320 μm and 360 μm capillary columns flowing at 1-6 μL/min. The collection takes place in the pipette tip, and the reconstitution is typically approximately 250 nL, generating a large gain in sample concentration, for applications that are not sample limited. This procedure is also applicable to techniques which include splitting the flow from the nanoLC column with 20 nL/min going to the ESI Chip for an on-line analysis, and the remainder being collected in the pipette tips, for applications that are sample limited. Finally, this technology is suitable for use with capillary electrophoresis/mass spectrometry (“CE/MS”). The present ultra-low volume fraction collection technique is potentially advantageous for CE/MS by eliminating the need for a robust CE/MS electrospray interface. Monton et al., Anal. Sci. 21:5-13 (2005), which is hereby incorporated by reference in its entirety. The present approach can be used for collection from any suitable liquid delivery or supplying device and is not limited to LC applications.

The invention will be further illustrated with reference to the following specific examples. It is understood that these examples are given by way of illustration and are not meant to limit the disclosure or the claims to follow.

### EXAMPLES

Reagents:

Modified trypsin was purchased from Promega (Madison, Wis.). Bovine RNase B and fetuin were obtained from Sigma (St. Louis, Mo.). Methanol, acetonitrile, and water were from Burdick & Jackson (Muskegon, Mich.). All other chemicals were purchased from Aldrich (Milwaukee, Wis.).

### Example 1

### Sample Preparation

Fetuin and RNase B were each dissolved in a separate denaturing solution containing 6.0 M guandidine-HCl, 10 mM dithiothreitol, and 50 mM Tris pH 8.0 at 10 mg/mL. The two solutions were incubated at 50° C. for 45 min. Then iodoacetamide was added to each denatured protein solution at a final concentration of 25 mM. After sitting at room temperature for 45 min. in darkness, the two solutions were each diluted 1:10 in 50 mM ammonium bicarbonate pH 7.8, to form solutions containing 1 mg/mL of denatured protein. Trypsin was then added to each solution at an enzyme-to-substrate ratio of 1:50 (w/w). Digestions were performed at 37° C. for 16 hours and stopped by the addition of 0.1% (v/v) acetic acid. The two individual digests were stored at −20° C.

### Example 2

### NanoLC Separation

For the nanoLC analysis of the fetuin digest prepared in Example 1, an UltiMate 3000 nanoLC system from Dionex (Sunnyvale, Calif.) and a C₁₈ PepMap 100 (75 μm×15 cm, 3 μm, 100 Å) also from LC Packings (Sunnyvale, Calif.) were used. Mobile phase A was water with 0.2% formic acid, and mobile phase B was 80% acetonitrile in water with 0.2% formic acid. The gradient included a 10 minute desalt step with 0% mobile phase B, then from 10 to 45 minutes, mobile phase B was increased from 0% to 50%. After a 5 minute 100% mobile phase B column wash, mobile phase B was reduced to 0%, and the column was allowed to equilibrate for 45 minutes prior to another injection. The flow rate from the column was 280 nL/min, and the column oven temperature was maintained at 30° C. A 1 μL full loop injection, injecting a total of 1 pmol of fetuin tryptic digest prepared in Example 1 on-column was performed.

Both conventional on-line and nanoFACT fraction collection experiments were performed on the fetuin sample. The conventional online approach was conducted by directly electrospraying the LC effluent into the orifice of the mass spectrometer at ˜hundreds nL/min, as set forth in Example 5. The ionization solvent composition is dependent on the LC separation and the MS analysis time is limited to the peak elution window—typically less than 30 seconds. For the nanoFACT experiment, the LC effluent was collected into the pipette tips, as set forth in Example 3, the fractions were dried, followed by reconstitution in a preferred ionization solvent, as set forth in Example 4, with subsequent electrospray infusion analysis of the fractions via nanoelectrospray conducted at ˜20 nL/minute, as set forth in Example 5. This fraction collection allows for optimizing ionization solvents and extending analysis times to greater than 10 minutes.

For the nanoLC separation of RNase B, an LC Packings UltiMate nanoLC system from Dionex (Sunnyvale, Calif.) and a NanoEase Atlantis C₁₈ nanoLC column (75 μm×15 cm, 3 μm, 100 Å) from Waters (Milford, Mass.) were used. Mobile phase A was water with 0.1% acetic acid and 0.01% heptafluorobutyric acid, while mobile phase B was acetonitrile with 0.1% acetic acid and 0.01% heptafluorobutyric acid. The gradient included a 9 minute desalt step with 0% mobile phase B, then from 9 to 10 minutes, mobile phase B was increased from 0% to 5%. From 10 to 55 minutes, mobile phase B was ramped up from 5% to 50% to elute peptides from the column. After a 5 minute 100% mobile phase B column wash, mobile phase B was reduced to 0%, and the column was allowed to equilibrate for 40 minutes prior to another injection. The flow rate from the column was 250 nL/min and a total of 100 fmol of RNase B tryptic digest prepared in Example 1 was injected on-column. Both conventional on-line and nanoFACT fraction collection experiments were performed on the RNase B sample.

The conventional online approach was conducted by directly electrospraying the LC effluent into the orifice of the mass spectrometer at ˜hundreds nL/min, as set forth in Example 5. The ionization solvent composition is dependent on the LC separation and the MS analysis time is limited to the peak elution window—typically less than 30 seconds. For the nanoFACT experiment, the LC effluent is collected into the pipette tips, as set forth in Example 3, the fractions are dried, followed by reconstitution in a preferred ionization solvent, as set forth in Example 4, with subsequent electrospray infusion analysis of the fractions via nanoelectrospray conducted at ˜20 nL/minute, as set forth in Example 5. This fraction collection allows for one to optimize ionization solvents and extend analysis times to greater than 10 minutes.

### Example 3

### NanoFACT Fraction Collection

NanoLC fraction collection into pipette tips for both the fetuin and RNase B samples separated in Example 2, was performed using a NanoMate. For the fetuin sample, nanoLC fractions were collected every 60 sec for a fraction volume of 280 nL, disregarding evaporative losses during the collection. For the RNase B sample, nanoLC fractions were collected into pipette tips every 90 seconds, for a total collection volume of 375 nL, again with the evaporation losses of the fraction during the collection disregarded.

### Example 4

### Reconstitution of NanoLC Fractions

Automated reconstitution of the nanoLC fractions collected in Example 3 was achieved using a NanoMate. The fractions collected from the fetuin tryptic digest were reconstituted in 50% methanol in water with 1.0% formic acid. The initial volume of reconstitution solvent aspirated from a microtiter plate was 500 nL, but after the solvent evaporation brought about by three dispense-delay-aspirate cycles in the reconstitution process, the final volume of solvent analyzed was 250 nL. Each cycle of the reconstitution was composed of the reconstitution solvent being expelled as a droplet hanging on the exterior of the pipette, followed by a 4 second delay, and then aspiration of the droplet back into the tip. The number of dispense-delay-aspirate cycles is chosen based upon the desired final concentration. The above parameters are examples used for the application shown here, but other values could be implemented depending on the desired concentration and mixing.

For the RNase B tryptic digest collected in Example 3, the reconstitution solution was 35% methanol in water with 0.1% acetic acid. The initial volume of reconstitution solvent aspirated was 500 nL and after 3 dispense-delay-aspirate cycles during the reconstitution, there was approximately 250 nL of solvent remaining in the tip for analysis.

### Example 5

### Mass Spectrometry Conditions

All mass spectrometric analyses were performed on an LCQ Deca XP ion trap mass spectrometer from ThermoFinnigan (San Jose, Calif.). For on-line nanoLC analyses, data dependent acquisitions were performed with 1 MS scan followed by 3 MS/MS scans. The collision energy was set to 35% with the exclusion list enabled. For the on-line nanoLC experiments, the column was connected to a standard ESI Chip which was used as the spray device. The ESI Chip used was composed of 400 nozzles each with an inner diameter of 5.5 μm, and the chip could accept flow rates of 150-500 nL/min. The spray voltage used for the analysis was 1.7 kV. These parameters allowed for a stable spray from 100% aqueous through the gradient to 100% organic.

For nanoFACT analyses, manual MSⁿ was performed where the operator selected the ions of interest, and varied the amount of time to acquire each spectrum based on overall signal intensity. For the fetuin work, the collision energy was set to 35%, however for the RNase B study, the operator also optimized collision energies for the various glycopeptides observed. The ESI Chip used for the nanoFACT analysis contained 400 nozzles with inner diameters of 2.5 μm, and operated in the 20 nL/min regime. The spray voltage and delivery pressure used was 1.35 kV and 0.5 psi for this low flow chip.

### Example 6

### Phosphorylation Study

Bovine fetuin was used to investigate the utility of nanoFACT for phosphorylation analyses. Bovine fetuin is known to contain four serine phosphorylated post-translational modifications (Wind et al., Anal. Biochem., 317:26-33 (2003), which is hereby incorporated by reference in its entirety) and following a trypsin digestion, two phosphorylated peptides result: 132-CDSSPDS*AEDVR(K)-143 and 313-HTFSGVAS*VES*S*SGEAFHVGK-333, where the potential phosphorylation sites are indicated with an asterisk.

A comparative analysis between conventional on-line nanoLC and nanoFACT was performed. For the on-line nanoLC experiment 1 pmol of fetuin tryptic digest prepared in Example 1 was injected onto a 75 μm column with a flow rate of 280 nL/min. A standard ESI Chip with an inner diameter of 5.5 μm, capable of handling a 280 nL/min flow rate was used as the spray device, and the mass spectrometer was set to run a data dependent acquisition. Extracted ion chromatograms for the phosphopeptides of interest from this nanoLC experiment are shown in FIG. 4. FIG. 4A indicates that the peptide 132-CDSSPDS*AEDVR-143 was observed both without phosphorylation and with a single phosphorylation event. FIG. 4B shows the same peptide as in FIG. 4A but with one miscleavage. Both 2+ and 3+ charge states for the non-phosphorylated and singly phosphorylated peptide 132-CDSSPDS*AEDVRK-144 were observed as shown in FIG. 4B. In FIG. 4C the results from the second phosphopeptide, 313-HTFSGVAS*VES*S*SGEAFHVGK-333 of fetuin are shown. The non-phosphorylated, singly phosphorylated, and double phosphorylated peptides were observed however there was no evidence of the triply phosphorylated peptide that was expected. Furthermore, the data dependent acquisition failed to perform MS/MS on any ion corresponding to the expected triply phosphorylated peptide. However, all other expected phosphopeptides were observed and MS/MS data was obtained.

A second injection of 1 pmol fetuin digest was then made and instead of the column effluent going into the mass spectrometer, it was collected into pipette tips at a rate of one fraction per minute. Following the nanoFACT collection, and subsequent fraction dry-down, the pipette tips were reconstituted and immediately analyzed. In nanoFACT the reconstitution and analysis solvent choice is independent of the chromatography solvent. Therefore, one can select a reconstitution solvent to maximize ionization efficiency without needing to compromise chromatography. For the fetuin analysis, two different reconstitution solvents for two different collections were tried in order to assess how ionization efficiencies could be affected. In FIGS. 5A and B a non-phosphorylated and phosphorylated peptide, respectively, were reconstituted in 50% methanol in water with 0.4% formic acid. In FIGS. 5C and D the same non-phosphorylated and phosphorylated peptide, respectively, were reconstituted in 50% methanol in water with 1.0% formic acid. When comparing total signal intensities for the MS/MS spectra, the non-phosphorylated peptide had a 100-fold intensity improvement when reconstituted in the 0.4% formic acid solvent as compared to the 1.0% formic acid solvent. And the reverse was true for the phosphopeptide, as a 100-fold intensity improvement was observed when reconstituted in 1.0% formic acid compared to 0.4% formic acid. These results demonstrate that the choice of analysis solvent has very large effects on ionization efficiency and the ability to decouple chromatography solvent from analysis solvent is highly advantageous. Of course one could change LC mobile phases for an on-line analysis, however mobile phases cannot be changed within chromatographic runs, and changing mobile phases are time-consuming.

Since this work investigated phosphopeptides, the 50% methanol in water with 1.0% formic acid reconstitution solvent was selected. Once all nanoLC fractions of interest were analyzed, the MS/MS spectra of the phosphopeptides from the on-line nanoLC experiment and the nanoFACT experiment were compared. An example of nanoLC versus nanoFACT results are shown in FIGS. 6A and B respectively. Each nanoLC and nanoFACT spectrum from each of the various peptides of interest was searched for diagnostic ions (y, y²⁺, b, b²⁺, and losses of phosphate and/or water). The diagnostic ions observed for 313-HTFSGVApSVEpSSSGEAFHVGK-333 from MS/MS of nanoLC and nanoFACT are shown underlined in FIGS. 6A and 6B respectively. The number of diagnostic ions in all spectra of interest were counted and a summary of the finding is shown in Table 1. It is apparent that for both non-phosphorylated and phosphorylated peptides the number of diagnostic ions observed was higher using the nanoFACT approach over conventional nanoLC. The overall improvement in the number of diagnostic ions achieved by nanoFACT was 19% or greater for non-phosphorylated peptides and 55% or greater for phosphorylated peptides.

Furthermore, Table 1 also indicates that the triply phosphorylated peptide, 313-HTFSGVApSVEpSpSSGEAFHVGK-333 that was not observed using conventional nanoLC as shown in FIG. 4C, was in fact found using nanoFACT. The high quality MS/MS spectrum acquired for this triply phosphorylated peptide is shown in FIG. 7. The reasons why the nanoFACT approach was successful while the nanoLC failed are firstly because the reconstitution solvent was optimized for phosphopeptide ionization and was different from the chromatography solvent, and secondly that averaging many scans together was possible due to the long analysis time of 10 minutes. The MS/MS spectrum in FIG. 7 is an average of 376 scans, yielding improved data quality.

Another example of the benefits of data averaging that fraction collection can offer is shown in FIG. 8. In FIG. 8 m/z 1400 to 1800 is expanded for the MS/MS spectra of the non-phosphorylated peptide 313-HTFSGVASVESSSGEAFHVGK-333, m/z 707. The nanoLC data which is only from one single scan is shown in FIG. 8A and the nanoFACT data which is an average of 321 scans is shown in FIG. 8B. It is apparent from this figure that the data quality is superior in the nanoFACT spectrum because seven distinct diagnostic ions could be observed in the mass range shown, while only one questionable ion could be identified in the nanoLC spectrum. The improvement in data quality from signal averaging offered by nanoFACT is observed for all peptides regardless of phosphorylation presence. Furthermore, additional scan functions, MSⁿ experiments, and high resolution scanning could have been performed using appropriate MS instruments.

### Example 7

### Glycosylation Analysis

To demonstrate that nanoFACT can also be used for glycopeptide analysis, 100 fmol of RNase B tryptic digest was used. The glycosylation site of RNase B has been well characterized, (Zhang et al., J. Biomol. Techniques (2005) In press) and its structure is shown in the inset of FIG. 9B. The structure includes nine mannose groups attached to two N-acetyl-D-glucosamine groups which are subsequently attached to the tryptic peptide 33-NLTK-36.

First, a conventional on-line nanoLC experiment was performed. The resulting chromatogram using a nozzle on the ESI Chip as the spray device is shown in FIG. 9A. In this chromatogram the glycopeptides of the RNase B digest elute between 24 and 26 minutes. A data dependent acquisition was performed where MS/MS spectra were acquired for four of the five glycopeptides present (data not shown).

Following the on-line experiment, a second injection of 100 fmol of the same RNase B tryptic digest was made but the second time the nanoLC fractions were collected into pipette tips at a rate of one fraction every 90 seconds. Four nanoLC fractions of interest, shown in FIG. 9A, were each reconstituted with an initial volume of 500 nL of reconstitution solvent, but after three dispense-delay-aspirate cycles, the volume decreased to approximately 250 nL. Tips 1 and 4 showed no evidence of any glycopeptides in the full scan MS scans, but glycopeptides were present in tips 2 and 3. The full scan MS spectrum for tip 2 is shown in FIG. 9B. The major ions in the spectrum are spaced 81 Dalton apart, which is a typical pattern of doubly charged, high mannose-type glycopeptides. Five different high mannose-type glycopeptides are observed in the full scan spectrum corresponding from five mannose groups to nine mannose groups.

At this point the nanoLC fraction containing the glycopeptides of interest was being infused into the mass spectrometer, providing greater than ten minutes of analysis time. During this time a wide variety of tandem MS experiments were performed to characterize the structure. MS/MS was performed on each of the five glycopeptides of interest. As an example, MS/MS of m/z 1008.2 is shown in FIG. 10A. Then many different MS³ experiments were performed one of which is shown in FIG. 10B. Here the product ion spectrum resulting from the isolation and collisional dissociation of m/z 1170, followed by the subsequent isolation and collisional dissociation of m/z 927 is shown.

In glycosylation characterization one typically desires to learn the structure of the glycosylation site, the glycan attachment site on the peptide backbone, and the sequence of the peptide to which the glycan is attached. As glycopeptides tend to fragment only within their oligosaccharide structure in tandem MS experiments, it is often difficult to obtain amino acid sequence information. However the longer analysis times offered by the nanoFACT approach provide the opportunity to optimize collision energies, making it easier to obtain the amino acid sequence information. In FIG. 10C, an MS⁴ spectrum (m/z 1089 to m/z 678 to m/z 475) is shown where the amino acid sequence of the peptide containing the glycosylation site was discerned.

Glycosylation studies also benefit from nanoFACT's ability to signal average. In FIG. 10D, 232 scans were averaged together to obtain a respectable MS⁵ spectrum (m/z 927 to m/z 765 to m/z 684 to m/z 603). This high quality spectrum is particularly impressive when one considers only 100 fmol of digest was loaded on the column, the ionization challenges presented by hydrophilic glycopeptides, and a three-dimensional ion trap was the mass spectrometer used. Significantly higher concentrations have been reported using more sensitive mass spectrometers in the literature. Zhang et al., J. Biomol. Techniques, 15:120-133 (2004), which is hereby incorporated by reference in its entirety.

TABLE 1
NanoFACT Data Yields Increased Number of Diagnostic Ions
for Both Non-Phosphorylated and Phosphorylated Peptides
as Compared to NanoLC

| | | Number of Diagnostic | | |
|---|---|---|---|---|
| | | Ions Observed | | |
| | | On-line | | % |
| | Peptide | nanoLC | nanoFACT | Improvement |
| Non-Phosphorylated | m/z 669 | 16 | 21 | 31.3% |
| | m/z 489 | 16 | 24 | 50.0% |
| | m/z 733 | 21 | 25 | 19.0% |
| | m/z 707 | 33 | 64 | 93.9% |
| Phosphorylated | m/z 709 | 18 | 28 | 55.6% |
| | m/z 516 | 13 | 27 | 107.7% |
| | m/z 773 | 19 | 34 | 78.9% |
| | m/z 734 | 29 | 58 | 100.0% |
| | m/z 760 | 23 | 57 | 147.8% |
| | m/z 787 | 0* | 51 | —* |

Spectrum for m/z 787, 313-HTFSGVApSVEpSpSSGEAFHVGK-333, could not be obtained with on-line nanoLC.

While the invention has been described with preferred embodiments, it is to be understood that variations and modifications are to be considered within the purview and the scope of the claims appended hereto.

What is claimed is:

1. A method for collecting low volume liquid sample comprising,
positioning a deposition tube, having a dispensing end, within a collection tube, having a collection end, so that the end of the deposition tube protrudes out of the end of the collection tube;
feeding a liquid sample through the deposition tube until a desired volume of sample forms a droplet at the end of the deposition tube; and
retracting the deposition tube within the collection tube so that the sample droplet is collected in the end of the collection tube.

2. The method of claim 1, further comprising,
drying the collected sample;
aspirating a liquid into the collection tube to reconstitute the dried sample;
mixing and concentrating the reconstituted sample by exposing the sample to a desired number of cycles of expelling the sample and forming a droplet at the end of the collection tube exposing the expelled droplet to the atmosphere, and re-aspirating the droplet into the collection tube; and
subjecting the sample to a detector for analysis.

3. The method of claim 1, further comprising,
drying the collected sample;
aspirating a liquid into the collection tube to reconstitute the dried sample;
mixing and concentrating the reconstituted sample by agitation within the collection tube by exposing the sample to a desired number of cycles of aspiration and dispense such that the sample remains within the collection tube; and
subjecting the sample to a detector for analysis.

4. The method of claim 1, further comprising,
drying the collected sample;
aspirating a liquid into the collection tube to reconstitute the dried sample;
mixing the liquid and sample within the collection tube by holding the mixture within the collection tube for a desired amount of time; and
subjecting the sample to a detector for analysis.

5. The method of claim 1, further comprising,
concentrating the collected sample volume by exposing the sample to a desired number of cycles of expelling the sample and forming a droplet at the end of the collection tube exposing the expelled droplet to the atmosphere, and re-aspirating the droplet into the collection tube; and
subjecting the sample to a detector for analysis.

6. The method of claim 1, wherein the collected sample has a volume of 25 nL.

7. The method of claim 2, wherein the reconstituted droplet is exposed to the atmosphere in a vacuum, an atmosphere having a positive pressure, an atmosphere having a negative pressure, or an atmosphere having a pure gas or a mixture of two or more gasses.

8. The method of claim 1, wherein the collected sample is dried, reconstituted in a desired liquid, partially expelled for analysis, the remaining sample is dried followed by reconstitution in one or more additional liquids, and expelled for analysis.

9. The method of claim 1, wherein the collected sample is dried, reconstituted in a desired liquid, partially expelled for analysis, the remaining sample is mixed with one or more additional aspirated liquids, and expelled for analysis.

10. The method of claim 1, wherein the dried sample is archived in the collection tube for later analysis.

11. The method of claim 1, wherein the collection tube has an inner surface which has been chemically modified to minimize analyte adsorption or fractionate the sample.

12. The method of claim 1, wherein the liquid sample fed through the deposition tube comprises a liquid chromatography fraction.

13. A method for collecting low volume liquid sample comprising,
positioning a deposition tube, having a dispensing end, within a collection tube, having a collection end, so that the end of the deposition tube is in a retracted or near co-planar position relative to the end of the collection tube;
feeding a liquid sample through the deposition tube until a desired volume of sample collects within the end of the collection tube; and
withdrawing the deposition tube completely from within the collection tube without disturbing the sample collected in the end of the collection tube.

14. The method of claim 13, further comprising,
drying the collected sample;
aspirating a liquid into the collection tube to reconstitute the dried sample;
mixing and concentrating the reconstituted sample by exposing the sample to a desired number of cycles of expelling the sample and forming a droplet at the end of the collection tube exposing the expelled droplet to the atmosphere, and re-aspirating the droplet into the collection tube; and
subjecting the sample to a detector for analysis.

15. The method of claim 13, further comprising,
drying the collected sample;
aspirating a liquid into the collection tube to reconstitute the dried sample;
mixing and concentrating the reconstituted sample by agitation within the collection tube by exposing the sample to a desired number of cycles of aspiration and dispense such that the sample remains within the collection tube; and
subjecting the sample to a detector for analysis.

16. The method of claim 13, further comprising,
drying the collected sample;
aspirating a liquid into the collection tube to reconstitute the dried sample;
mixing the liquid and sample within the collection tube by holding the mixture within the collection tube for a desired amount of time; and
subjecting the sample to a detector for analysis.

17. The method of claim 13, further comprising,
concentrating the collected sample volume by exposing the sample to a desired number of cycles of expelling the sample and forming a droplet at the end of the collection tube exposing the expelled droplet to the atmosphere, and re-aspirating the droplet into the collection tube; and
subjecting the sample to a detector for analysis.

18. The method of claim 13, wherein the collected sample has a volume of 25 nL.

19. The method of claim 13, wherein the reconstituted droplet is exposed to the atmosphere in a vacuum, an atmosphere having a positive pressure, an atmosphere having a negative pressure, or an atmosphere having a pure gas or a mixture of two or more gasses.

20. The method of claim 13, wherein the collected sample is dried, reconstituted in a desired liquid, partially expelled for analysis, the remaining sample is dried followed by reconstitution in one or more additional liquids, and expelled for analysis.

21. The method of claim 13, wherein the collected sample is dried, reconstituted in a desired liquid, partially expelled for analysis, the remaining sample is mixed with one or more additional aspirated liquids, and expelled for analysis.

22. The method of claim 13, wherein the dried sample is archived in the collection tube for later analysis.

23. The method of claim 13, wherein the collection tube has an inner surface which has been chemically modified to minimize analyte adsorption.

24. The method of claim 13, wherein the liquid sample fed through the deposition tube comprises a liquid chromatography fraction.

25. The method of claim 13, wherein the capillary tube is withdrawn continuously as the liquid sample is being fed through the capillary, so as to maintain the tip of the capillary at or above the rising level of the liquid sample being collected in the pipette tip.

26. A method for collecting low volume liquid sample comprising,
positioning a deposition tube, having a dispensing end, within a collection tube, having a collection end, so that the end of the deposition tube protrudes through the end of the collection tube and into the interior of the collection tube;
feeding a liquid sample through the deposition tube until a desired volume of sample forms a droplet at the end of the deposition tube; and
withdrawing the deposition tube from within the collection tube so that the sample droplet is collected in the end of the collection tube.

27. The method of claim 26, further comprising,
drying the collected sample;
aspirating a liquid into the collection tube to reconstitute the dried sample;
mixing and concentrating the reconstituted sample by exposing the sample to a desired number of cycles of expelling the sample and forming a droplet at the end of the collection tube exposing the expelled droplet to the atmosphere, and re-aspirating the droplet into the collection tube; and
subjecting the sample to a detector for analysis.

28. The method of claim 26, further comprising,
drying the collected sample;
aspirating a liquid into the collection tube to reconstitute the dried sample;
mixing and concentrating the reconstituted sample by agitation within the collection tube by exposing the sample to a desired number of cycles of aspiration and dispense such that the sample remains within the collection tube; and
subjecting the sample to a detector for analysis.

29. The method of claim 26, further comprising,
drying the collected sample;
aspirating a liquid into the collection tube to reconstitute the dried sample;
mixing the liquid and sample within the collection tube by holding the mixture within the collection tube for a desired amount of time; and
subjecting the sample to a detector for analysis.

30. The method of claim 26, further comprising,
concentrating the collected sample volume by exposing the sample to a desired number of cycles of expelling the sample and forming a droplet at the end of the collection tube exposing the expelled droplet to the atmosphere, and re-aspirating the droplet into the collection tube; and
subjecting the sample to a detector for analysis.

31. The method of claim 26, wherein the collected sample has a volume of 25 nL.

32. The method of claim 26, wherein the reconstituted droplet is exposed to the atmosphere in a vacuum, an atmosphere having a positive pressure, an atmosphere having a negative pressure, or an atmosphere having a pure gas or a mixture of two or more gasses.

33. The method of claim 26, wherein the collected sample is dried, reconstituted in a desired liquid, partially expelled for analysis, the remaining sample is dried followed by reconstitution in one or more additional liquids, and expelled for analysis.

34. The method of claim 26, wherein the collected sample is dried, reconstituted in a desired liquid, partially expelled for analysis, the remaining sample is mixed with one or more additional aspirated liquids, and expelled for analysis.

35. The method of claim 26, wherein the dried sample is archived in the collection tube for later analysis.

36. The method of claim 26, wherein the collection tube has an inner surface which has been chemically modified to minimize analyte adsorption.

37. The method of claim 26, wherein the liquid sample fed through the deposition tube comprises a liquid chromatography fraction.

38. A method for collecting low volume liquid sample comprising,
positioning a deposition tube, having a dispensing end, within a collection tube, having a collection end, so that the dispensing end of the deposition tube protrudes through the end of the collection tube and into the interior of the collection tube in a protruded or near co-planar position relative to the end of the collection tube;
feeding a liquid sample through the deposition tube until a desired volume of sample collects within the end of the collection tube; and
withdrawing the deposition tube completely from within the collection tube without disturbing the sample collected in the end of the collection tube.

39. The method of claim 38, further comprising,
drying the collected sample;
aspirating a liquid into the collection tube to reconstitute the dried sample;
mixing and concentrating the reconstituted sample by exposing the sample to a desired number of cycles of expelling the sample and forming a droplet at the end of the collection tube exposing the expelled droplet to the atmosphere, and re-aspirating the droplet into the collection tube; and
subjecting the sample to a detector for analysis.

40. The method of claim 38, further comprising,
drying the collected sample;
aspirating a liquid into the collection tube to reconstitute the dried sample;
mixing and concentrating the reconstituted sample by agitation within the collection tube by exposing the sample to a desired number of cycles of aspiration and dispense such that the sample remains within the collection tube; and
subjecting the sample to a detector for analysis.

41. The method of claim 38, further comprising,
drying the collected sample;
aspirating a liquid into the collection tube to reconstitute the dried sample;
mixing the liquid and sample within the collection tube by holding the mixture within the collection tube for a desired amount of time; and
subjecting the sample to a detector for analysis.

42. The method of claim 38, further comprising,
concentrating the collected sample volume by exposing the sample to a desired number of cycles of expelling the sample and forming a droplet at the end of the collection tube exposing the expelled droplet to the atmosphere, and re-aspirating the droplet into the collection tube; and
subjecting the sample to a detector for analysis.

43. The method of claim 38, wherein the collected sample has a volume of 25 nL.

44. The method of claim 38, wherein the reconstituted droplet is exposed to the atmosphere in a vacuum, an atmosphere having a positive pressure, an atmosphere having a negative pressure, or an atmosphere having a pure gas or a mixture of two or more gasses.

45. The method of claim 38, wherein the collected sample is dried, reconstituted in a desired liquid, partially expelled for analysis, the remaining sample is dried followed by reconstitution in one or more additional liquids, and expelled for analysis.

46. The method of claim 38, wherein the collected sample is dried, reconstituted in a desired liquid, partially expelled for analysis, the remaining sample is mixed with one or more additional aspirated liquids, and expelled for analysis.

47. The method of claim 38, wherein the dried sample is archived in the collection tube for later analysis.

48. The method of claim 38, wherein the collection tube has an inner surface which has been chemically modified to minimize analyte adsorption.

49. The method of claim 38, wherein the liquid sample fed through the deposition tube comprises a liquid chromatography fraction.

50. A method for collecting and preparing for analysis low volume liquid sample comprising,
positioning a deposition tube, having a dispensing end, within a collection tube, having a collection end, so that the dispensing end of the deposition tube is positioned to deliver a liquid sample to the collection end of the collection tube;
feeding the liquid sample containing an analyte through the deposition tube until a desired volume of sample is collected in the collection end of the collection tube; and
performing one or more of the following:
concentrating the sample;
drying the collected sample,
aspirating a second liquid into the collection tube,
reconstituting the dried sample in the collection tube, and
injecting the sample to a detector for direct analysis; wherein the same tube is used for collection, reconstitution, and injection of the sample.

51. A method for concentrating a liquid sample comprising,
collecting a liquid sample in a collection tube;
concentrating the collected sample volume by exposing the sample to a desired number of cycles of expelling the sample and forming a droplet at the end of the collection tube exposing the expelled droplet to the atmosphere, and re-aspirating the droplet into the collection tube; and
subjecting the concentrated sample to a detector for analysis.

52. The method of claim 51, wherein the concentrated sample volume is an amount between about 5 μL and about 25 nL.

53. A method for concentrating a liquid sample, comprising:
providing a collection tube open at each end;
partially filling the collection tube with liquid sample such that the liquid sample is collected at one end of the tube and forming a plug of liquid sample extending from the filled end of the tube to a location within the non-filled portion of the tube;
exposing each end of the tube to the surrounding environment; and
drying the sample such that the evaporation rate of the portion of the liquid plug nearest the filled end of the tube is greater than the evaporation rate of the portion of the liquid plug nearest the non-filled end of the tube, causing the sample to concentrate at the filled end of the tube.

54. The method according to claim 53, wherein the evaporation is accelerated by passing an inert gas across the filled end of the tube.
